(19) United States
(12) Patent Application Publication
(10) Pub. No.: US 2005/0078253 A1
(43) Pub. Date: Apr. 14, 2005

(54) Liquid crystal display and thin film transistor array panel therefor

(76) Inventors: Hee-Seop Kim, Hwaseong-si (KR); Doo-Hwan You, Suwon-si (KR); Jae-Jin Lyu, Kwangju-gun (KR)

Correspondence Address: MCGUIREWOODS, LLP, 1750 TYSONS BLVD, SUITE 1800, MCLEAN, VA, 22102, US

(21) Appl. No.: 10/909,833

(22) Filed: Aug. 3, 2004

(30) Foreign Application Priority Data
Aug. 4, 2003 (KR) 2003-0053736
Aug. 13, 2003 (KR) 2003-0056068

(51) Int. Cl. G02F 1/1343

(52) U.S. Cl. 349/139; 349/146

(57) ABSTRACT

A thin film transistor array panel for an LCD, and an LCD with the array panel are disclosed. The film transistor array panel comprises a signal line formed on a substrate, and a second signal line, having at least a bent portion, formed on the substrate. A pixel area is defined by the first signal line and the second signal line, and a first pixel electrode and a second pixel electrode are disposed in the pixel area. The pixel area has a bent shape, the first pixel electrode is coupled to a thin film transistor, and the second pixel electrode is coupled to the first pixel electrode.

This application claims the benefit of Korean Patent Application No. 2003-0053736, filed on Aug. 4, 2003, and Korean Patent Application No. 2003-0056068, filed on Aug. 13, 2003, which are hereby incorporated by reference for all purposes as if fully set forth herein.

### BACKGROUND OF THE INVENTION

1. Field of the Invention

The present invention relates to a liquid crystal display and a thin film transistor array panel.

2. Discussion of the Related Art

A liquid crystal display (LCD) is one of the most widely used flat panel displays. An LCD includes two panels provided with field-generating electrodes and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

A conventional LCD has a narrow viewing angle. Various techniques for expanding the viewing angle have been suggested, and a technique utilizing a vertically aligned LC and providing cutouts or protrusions at the field-generating electrodes, such as pixel electrodes and a common electrode, is promising.

Maximizing pixel electrode size has been suggested since the cutouts and the protrusions reduce the aperture ratio. However, proximity of pixel electrodes causes strong lateral electric fields between them, which dishevels LC molecule orientations to yield textures and light leakage, thereby deteriorating display characteristics.

Alternatively, an LCD using cutouts or protrusions shows an excellent viewing angle of over 80 degrees in any direction, in view of a contrast ratio where 1:10 is a standard contrast ratio and in view of gray scale inversion where a viewing angle of occurring brightness inversion is a standard angle. However, such an LCD's visibility is inferior to a twisted nematic mode LCD. The poor visibility is caused by a discordance of the gamma curve between front and side views.

For example, in a vertically aligned mode LCD using cutouts, as the viewing angle increases, the picture plane becomes brighter and the color shifts toward white. When this phenomenon is excessive, it distorts the image because the brightness difference between gray scales disappears.

Widening use of the LCD in multimedia displays increases the importance of visibility.

### SUMMARY OF THE INVENTION

This present invention provides an LCD with a wide viewing angle and high image quality.

Additional features of the invention will be set forth in the description which follows, and in part will be apparent from the description, or may be learned by practice of the invention.

The present invention discloses, a thin film transistor array panel for an LCD, comprising a signal line formed on a substrate, and a second signal line, having at least a bent portion, formed on the substrate. A pixel area is defined by the first signal line and the second signal line, and a first pixel electrode and a second pixel electrode are disposed in the pixel area. The pixel area has a bent shape, the first pixel electrode is coupled to a thin film transistor, and the second pixel electrode is coupled to the first pixel electrode.

This present invention also discloses a thin film transistor array panel for an LCD, comprising a first signal line formed on a substrate, a second signal line, having at least a bent portion, formed on the substrate. A pixel area is defined by the first signal line and the second signal line. A first pixel electrode and a second pixel electrode are disposed in the pixel area and electrically floated from a thin film transistor. A direction control electrode is disposed in the pixel area and coupled to the thin film transistor. The pixel area has a bent shape, and a portion of at least one of the first pixel electrode or the second pixel electrode overlaps the direction control electrode.

This present invention also discloses a liquid crystal display (LCD), comprising an upper substrate, a lower substrate, and a liquid crystal layer interposed therebetween. The lower substrate further comprises a first signal line formed on the lower substrate, and a second signal line, having at least a bent portion, formed on the lower substrate. A pixel area is defined by the first signal line and the second signal line, and a first pixel electrode and a second pixel electrode are disposed in the pixel area. At least a portion of the pixel area has a bent shape. The first pixel electrode is coupled to a thin film transistor, and the second pixel electrode is coupled to the first pixel electrode.

This present invention also discloses a liquid crystal display, comprising an upper substrate, a lower substrate, and a liquid crystal layer interposed therebetween. The lower substrate further comprises a first signal line formed on the lower substrate, and a second signal line, having at least a bent portion, formed on the lower substrate. A pixel area is defined by the first signal line and the second signal line. A first pixel electrode and a second pixel electrode are disposed in the pixel area and electrically floated from a thin film transistor. A direction control electrode is disposed in the pixel area and coupled to the thin film transistor. The pixel area has a bent shape, and a portion of at least one of the first pixel electrode or the second pixel electrode overlaps the direction control electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plan view of a thin film transistor array panel for an LCD according to a first exemplary embodiment of the present invention.

FIG. 2 is a plan view of a common electrode panel for an LCD according to the first exemplary embodiment of the present invention.

FIG. 3 is a plan view of an LCD according to the first exemplary embodiment shown in FIG. 1 and FIG. 2.

FIG. 4 is a sectional view of the LCD shown in FIG. 3 taken along the line IV-IV′.

FIG. 5 is a circuit diagram of the LCD shown in FIG. 1, FIG. 2, FIG. 3 and FIG. 4.

FIG. 6 is a plan view of an LCD according to a second exemplary embodiment of the present invention.

FIG. 7 is a plan view of a thin film transistor array panel for an LCD according to a third exemplary embodiment of the present invention.

FIG. 8 is a plan view of a common electrode panel for an LCD according to the third exemplary embodiment of the present invention.

FIG. 9 is a plan view of an LCD according to the third exemplary embodiment shown in FIG. 7 and FIG. 8.

FIG. 10 is a plan view of an LCD according to a fourth exemplary embodiment of the present invention.

FIG. 11 is a sectional view of the LCD shown in FIG. 10 taken along the line XI-XI′.

FIG. 12 is a plan view of an LCD according to a fifth exemplary embodiment of the present invention.

FIG. 13 is a plan view of an LCD according to a sixth exemplary embodiment of the present invention.

FIG. 14 is a plan view of a thin film transistor array panel for an LCD according to a seventh exemplary embodiment of the present invention.

FIG. 15 is a plan view of a common electrode panel for an LCD according to the seventh exemplary embodiment of the present invention.

FIG. 16 is a plan view of an LCD according to the seventh exemplary embodiment shown in FIG. 14 and FIG. 15.

FIG. 17 is a sectional view of the LCD shown in FIG. 16 taken along the line XVII-XVII′.

FIG. 18 is a plan view of an LCD according to an eight exemplary embodiment of the present invention.

FIG. 19 is a plan view of an LCD according to a ninth exemplary embodiment of the present invention.

FIG. 20 is a sectional view of the LCD shown in FIG. 19 taken along the line XX-XX′.

FIG. 21 is a circuit diagram of the LCD shown in FIG. 19 and FIG. 20.

FIG. 22 is a conceptual diagram of the LCD shown in FIG. 19 and FIG. 20.

FIG. 23 is a plan view of an LCD according to a tenth exemplary embodiment of the present invention.

FIG. 24 is a plan view of an LCD according to an eleventh exemplary embodiment of the present invention.

FIG. 25 is a circuit diagram of the LCD shown in FIG. 24.

FIG. 26 is a plan view of an LCD according to a twelfth exemplary embodiment of the present invention.

FIG. 27 is a plan view of an LCD according to a thirteenth exemplary embodiment of the present invention.

FIG. 28 is a plan view of an LCD according to a fourteenth exemplary embodiment of the present invention.

### DETAILED DESCRIPTION OF THE PREFERRED EMBODIMENTS

The present invention will now be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. When an element such as a layer, film, region, or substrate is referred to as being “on” another element, it may be directly on the other element or intervening elements may also be present. In contrast, when an element is referred to as being “directly on” another element, there are no intervening elements present.

Now, liquid crystal displays (LCD) and thin film transistor (TFT) array panels for LCDs according to embodiments of the present invention will be described with reference to the accompanying drawings.

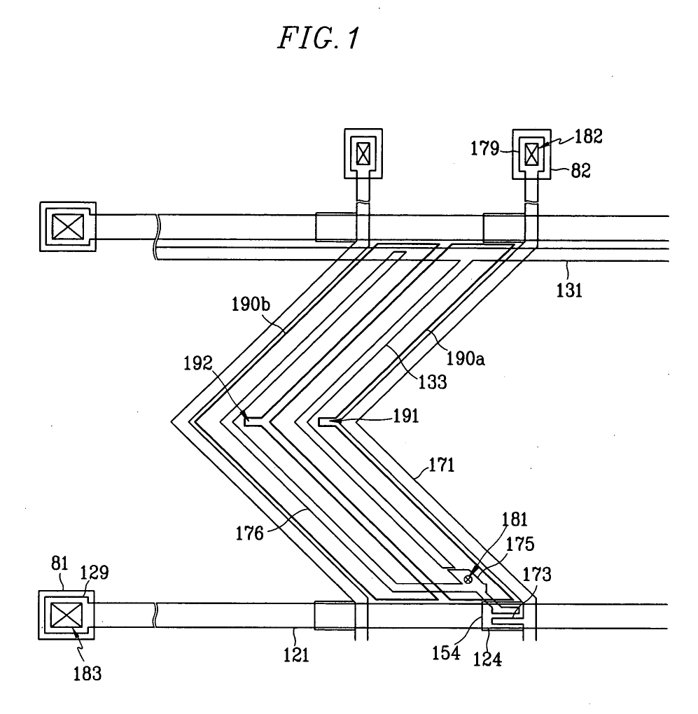

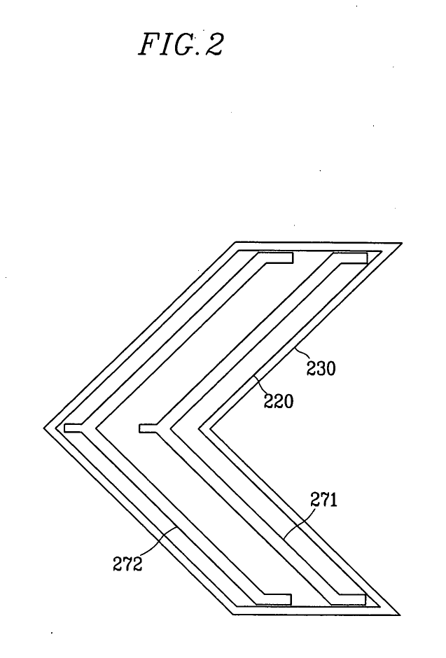

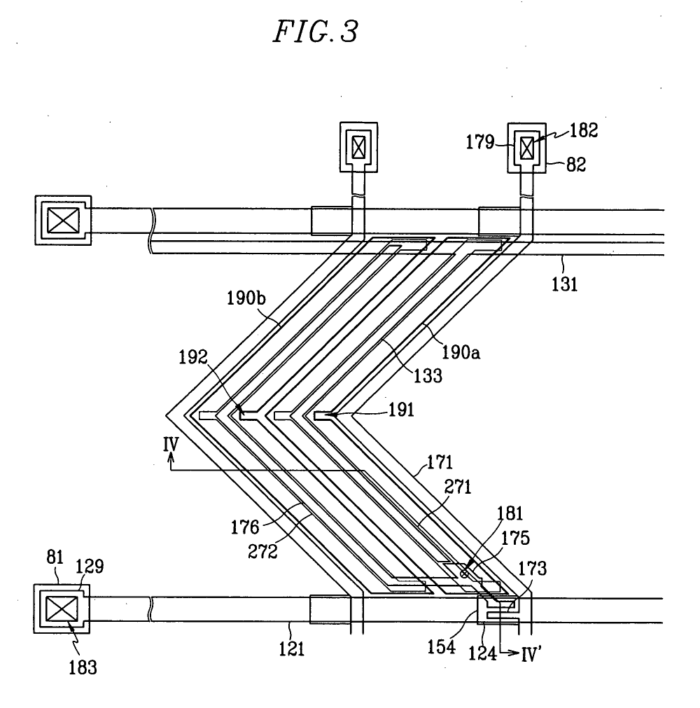

FIG. 1 is a plan view of a thin film transistor array panel for an LCD according to a first exemplary embodiment of the present invention, FIG. 2 is a plan view of a common electrode panel for an LCD according to the first exemplary embodiment of the present invention, FIG. 3 is a plan view of an LCD according to the embodiment shown in FIGS. 1 and 2, and FIG. 4 is a sectional view of the LCD shown in FIG. 3 taken along the line IV-IV′.

An LCD according to the first exemplary embodiment of the present invention is includes a TFT array panel 100, a common electrode panel 200, and an LC layer 3 interposed therebetween. The LC layer 3 contains a plurality of LC molecules aligned vertical to surfaces of the panels 100 and 200.

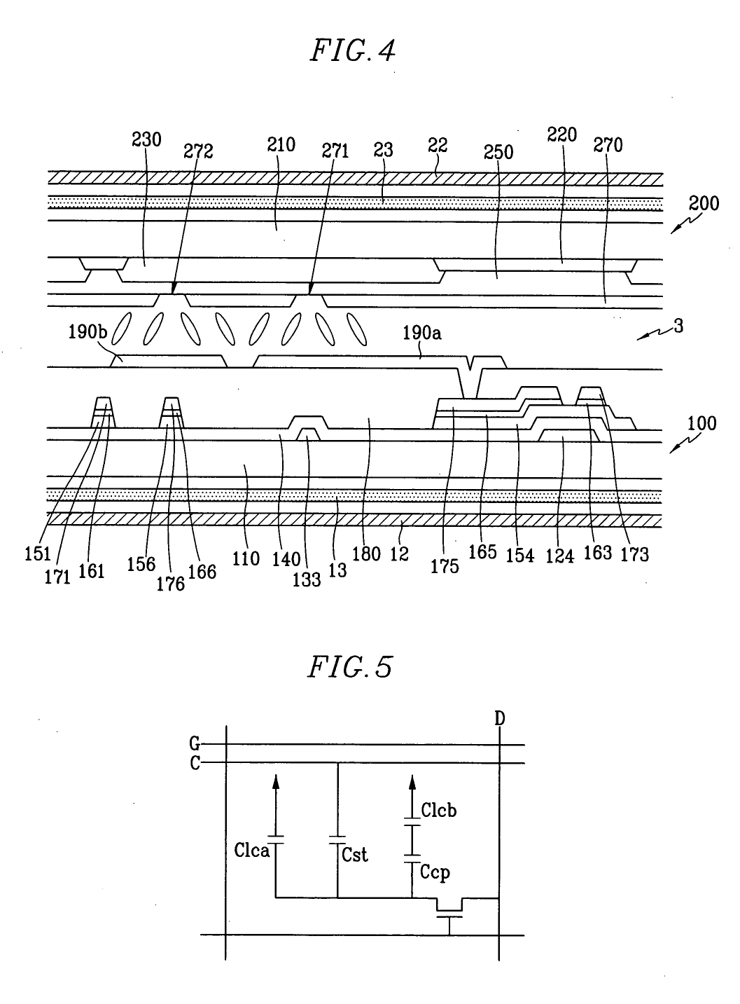

The TFT array panel 100 will now be described in detail with reference to FIGS. 1 and 4.

A plurality of gate lines 121 and a plurality of storage electrode lines 131 are formed on an insulating substrate 110.

The gate lines 121, which transmit gate signals, extend substantially in a transverse direction and are separated from each other. The gate line 121 has a plurality of gate electrodes 124 and gate pads 129 for connecting to an external circuit.

Each storage electrode line 131 extends substantially in the transverse direction and includes a plurality of branches forming storage electrodes 133. The storage electrode 133 includes a pair of oblique portions making an angle of about 45 degrees with the storage line 131 and making an angle of about 90 degrees with each other. The storage electrode lines 131 are supplied with a predetermined voltage such as a common voltage, which is also applied to a common electrode 270 on the common electrode panel 200 of the LCD.

The gate lines 121 and the storage electrode lines 131 may have a multi-layered structure including a lower film (not shown) and an upper film (not shown). The upper film is preferably made of low resistivity metal including an Al-containing metal such as Al and Al alloy for reducing signal delay or voltage drop in the gate lines 121 and the storage electrode lines 131. On the other hand, the lower film is preferably made of a material such as Cr, Mo, or a Mo alloy, which have good contact characteristics with other materials such as indium tin oxide (ITO) and indium zinc oxide (IZO). A good exemplary combination of the lower film is material and the upper film material is Cr and an Al-Nd alloy, respectively.

In addition, the lateral sides of the gate lines 121 and the storage electrode lines 131 are tapered, and the inclination angle of the lateral sides with respect to a surface of the substrate 110 ranges from about 30 to about 80 degrees.

A gate insulating layer 140, preferably made of silicon nitride (SiNx), is formed on the gate lines 121 and the storage electrode lines 131.

A plurality of semiconductor stripes 151, preferably made of hydrogenated amorphous silicon (abbreviated to “a-Si”), are formed on the gate insulating layer 140. Each semiconductor stripe 151 extends substantially in the longitudinal direction and has a plurality of projections 154 branched out toward the gate electrodes 124. An extension 156 is elongated from the projection 154.

Each of the semiconductor stripes 151 is bent repeatedly and includes a plurality of pairs of oblique portions and a plurality of longitudinal portions. Two oblique portions making a pair are connected to each other to form a chevron, and opposite ends of the pair are connected to respective longitudinal portions. The oblique portions make an angle of about 45 degrees with the gate lines 121, and the longitudinal portions cross over the gate electrodes 124. The length of a pair of oblique portions is about one to nine times the length of the longitudinal portion. In other words, the oblique portions form about 50-90 percent of the total length of the pair of oblique portions and the longitudinal portions.

The extension 156 includes a drain portion extended obliquely from the projection 154, a pair of oblique portions making an angle of about 45 degrees with the gate lines 121, and a connector connecting the drain portion and an end of the pair of oblique portions.

A plurality of ohmic contact stripes and islands 161 and 165, preferably made of is silicide or n+ hydrogenated a-Si heavily doped with n-type impurities, are formed on the semiconductor stripes 151 and projections 154. Each ohmic contact stripe 161 has a plurality of projections 163, and the projections 163 and the ohmic contact islands 165 are located in pairs on the projections 154 of the semiconductor stripes 151.

The edge surfaces of the semiconductor stripes 151 and the ohmic contacts 161, 165, and 166 are tapered, and the inclination angles of the edge surfaces of the semiconductor stripes 151 and the ohmic contacts 161, 165, and 166 are preferably in a range of about 30 to about 80 degrees.

A plurality of data lines 171, a plurality of drain electrodes 175, and a plurality of coupling electrodes 176 are formed on the ohmic contacts 161, 165, and 166.

The data lines 171, which transmit data voltages, extend substantially in the longitudinal direction and intersect the gate lines 121 and the storage electrode lines 131. Each data line 171 is bent repeatedly and includes a plurality of pairs of oblique portions and a plurality of longitudinal portions. Two oblique portions making a pair are connected to each other to form a chevron, and their opposite ends are connected to respective longitudinal portions. The oblique portions of the data lines 171 make an angle of about 45 degrees with the gate lines 121, and the longitudinal portions cross over the gate electrodes 124. The length of a pair of oblique portions is about one to nine times the length of a longitudinal portion. In other words, the oblique portions form about 50-90 percent of the total length of the pair of oblique portions and the longitudinal portion.

Therefore, pixel areas defined by the gate line 121 and the data line 171 crossing have the shape of bent stripes.

Each data line 171 includes a data pad 179 that is wider to contact another layer or an external device. A plurality of branches of each data line 171, which project toward the drain electrodes 175, form a plurality of source electrodes 173. Each pair of the source electrodes 173 and the drain electrodes 175 is separated from each other and facing of each other with a gate electrode 124 there between. A gate electrode 124, a source electrode 173, and a drain electrode 175, along with a projection 154, forms a TFT with a channel formed in the projection 154 disposed between the source electrode 173 and the drain electrode 175.

The coupling electrode 176 extends from the drain electrode 175, elongated in a horizontal direction at a first portion, and then bent to be parallel with the pair of oblique portions of the data line 171. The second portion of the coupling electrode 176 makes an angle of about 135 degrees with the gate line 121, and the third portion of the coupling electrode 176 makes an angle of about 45 degrees with the gate line 121.

The data lines 171, the drain electrodes 175, and the coupling electrodes 176 may have a multi-layered structure including a lower film (not shown) and an upper film (not shown). The upper film is preferably made of a low resistivity metal including an Al-containing metal such as Al or an Al alloy for reducing signal delay or voltage drop in the data lines. On the other hand, the lower film is preferably made of a material such as Cr, Mo, or a Mo alloy, which has good contact characteristics with other materials such as ITO and IZO. A good exemplary combination of the lower film material and the upper film material is Cr and an Al-Nd alloy, respectively.

Additionally, the lateral sides of the data lines 171, the drain electrodes 175, and the coupling electrodes 176 are tapered, and the inclination angle of the lateral sides with respect to a surface of the substrate 110 ranges from about 30 to about 80 degrees.

A passivation layer 180 is formed on the data lines 171, the drain electrodes 175, and the coupling electrodes 176. The passivation layer 180 is preferably made of a flat photosensitive organic material and a low dielectric insulating material having a dielectric constant under 4.0, such as a-Si:C:O and a-Si:O:F formed by plasma enhanced chemical vapor deposition (PECVD), or an inorganic material such as silicon nitride and silicon oxide.

The passivation layer 180 has a plurality of contact holes 181 and 182 exposing the drain electrodes 175 and the data pads 179 of the data lines 171, respectively. The passivation layer 180 and the gate insulating layer 140 have a plurality of contact holes 183 exposing the gate pads 129 of the gate lines 121.

The sidewalls of the contact holes 181, 182, and 183 make an angle of about 30 to about 85 degrees with respect to the surface of the substrate 110, and are stepped.

The contact holes 181, 182, and 183 may have various planar shapes, such as a rectangular shape or a circular shape. The area of each contact hole 181, 182, and 183 is preferably greater than or equal to 0.5 mm×15 μm, and not larger than 2 mm×60 μm.

A plurality of pairs of pixel electrodes 190a and 190b, and a plurality of contact assistants 81 and 82, which are preferably made of ITO, IZO, or Cr, are formed on the passivation layer 180.

Each pixel has a first pixel electrode 190a and a second pixel electrode 190b. Each of pixel electrodes 190a and 190b has a shape of a bent band like the pixel area. Each of the pixel electrodes 190a and 190b has a cutout 191 and a cutout 192. The first pixel electrode 190a and the second pixel electrode 190b have substantially the same shape, dividing a pixel area into a right area and a left area, and occupying the right area and the left area, respectively. Therefore, the first pixel electrode 190a may correspond to the second pixel electrode 190b by a parallel movement along the gate lines 121.

The first pixel electrode 190a is physically and electrically connected to the drain electrodes 175 through the contact holes 181. The second pixel electrode 190b is physically and electrically floated, but it overlaps with the coupling electrode 176 to form coupling capacitances with the first pixel electrodes 190a. Therefore, the voltage of the second pixel electrode 190b depends on the voltage of the first pixel electrode 190a, and the voltage of the second pixel electrode 190b with respect to the common voltage is always less than that of the first pixel electrode 190a.

When a pixel area includes two sub-areas with somewhat different electric fields, lateral visibility may be improved by the mutual compensation in the two sub-areas.

The coupling relationship between the first pixel electrode 190a and the second pixel electrode 190b will be described later in detail with reference to FIG. 5.

The common electrode panel 200 will be described with respect to FIG. 2, FIG. 3 and FIG. 4.

A black matrix 220, for preventing light leakage, is formed on an insulating substrate 210 such as transparent glass.

A plurality of red, green, and blue color filters 230 are formed on the black matrix and the substrate 210 and extend substantially along the columns of the pixel areas.

An overcoat 250 is formed on the color filters 230 and the black matrix 220. A common electrode 270, preferably made of a transparent conductive material such as ITO or IZO, is formed on the overcoat 250 with a plurality of cutouts 271 and 272.

The cutouts 271 and 272 control domains, and are preferably about 9 μm to about 12 μm wide. When organic protrusions replace the cutouts 271, the organic protrusions are preferably about 5 μm to about 10 μm wide.

The color filters 230 extend substantially in the longitudinal direction along pixel columns defined by the black matrix 220, and they are bent repeatedly along the shape of the pixels area.

A pair of cutouts 271 and 272 of common electrode 270 are disposed in a pixel area and are bent along the shape of pixel area. The cutouts 271 and 272 are disposed to divide the first pixel electrode 190a and the second pixel electrode 190b, respectively, into right half portions and left half portions. Both ends of the cutouts 271 and 272 are bent and extend a predetermined length in a direction parallel with the gate lines 121. Centers of the cutouts 271 and 272 also extend to a predetermined length and are parallel with the gate lines 121. The centers of the cutouts 271 and 272 extend in a direction opposite to that of the ends of the cutouts 271 and 272.

The LCD includes a TFT array panel 100, a color filter array panel 200 facing the TFT array panel 100 and separated by a predetermined gap, and a liquid crystal layer 3 filled in the predetermined gap.

The LC molecules in the LC layer 3 are aligned such that their long axes are vertical to the surfaces of the panels 100 and 200 when there is no electric field. The liquid crystal layer 3 has negative dielectric anisotropy.

The thin film transistor array panel 100 and the color filter array panel 200 are assembled so that the first and second pixel electrodes 190a and 190b precisely correspond to the color filter 230. When the two panels 100 and 200 are assembled, the edges of the first and second pixel electrodes 190a and 190b and the cutouts 271 and 272 divide the pixel areas into a plurality of sub-areas. If the liquid crystal region on each sub-area is called a domain, a pixel region is divided into 4 domains by the cutouts 271 and 272.

The domains have two parallel longest edges, and the domain is preferably about 10 μm to about 30 μm wide.

A pair of polarizers 12 and 22 are provided on the outer surfaces of the panels 100 and 200 such that their transmissive axes are crossed, and one of the transmissive axes is parallel to the gate lines 121.

The LCD may further include at least one retardation film (e.g., an optical element that produces, for example, full, half or quarter wave phase changes of polarized light) for compensating for the retardation of the LC layer 3.

A primary electric field, substantially perpendicular to the surfaces of the panels 100 and 200, is generated by application of a common voltage to the common electrode 270 and a data voltage to the pixel electrodes 190a and 190b. The LC molecules tend to change their orientations in response to the electric field, such that their long axes are perpendicular to the field direction.

The cutouts 271 and 272 and the edges of the pixel electrodes 190a and 190b distort the primary electric field to have a horizontal component, which determines the tilt directions of the LC molecules. The horizontal component of the primary electric field adopts four different orientations, thereby forming four domains in the LC layer 3 where LC molecules are tilted in different directions. The horizontal component is perpendicular to the edges of the cutouts 271 and 272 and the edges of the pixel electrodes 190a and 190b. Accordingly, four domains having different tilt directions are formed in the LC layer 3. Alternatively, a plurality of protrusions (not shown) may be used in place of the cutouts 271 and 272 since protrusions may also control the tilt directions of the LC molecules.

The directions of a secondary electric field due to the voltage difference between the pixel electrodes 190a and 190b are perpendicular to each of the edges of the cutouts 271 and 272. Accordingly, the secondary electric field direction coincides with that of the horizontal component of the primary electric field. Consequently, the secondary electric field between the pixel electrodes 190a and 190b enhances the tilt directions of the LC molecules.

Since the LCD performs inversion (i.e., inverting the polarity of an applied voltage) such as dot inversion, column inversion, etc., a secondary electric field that enhances the tilt directions of the LC molecules is attained by supplying an adjacent pixel electrode with a data voltage having opposite polarity with respect to the common voltage. As a result, the secondary electric field direction generated between adjacent pixel electrodes is equivalent to the horizontal component of the primary electric field generated between the common and pixel electrodes. Thus, a secondary electric field may enhance the stability of the domains.

The tilt directions of all the domains form an angle of about 45 degrees with the gate lines 121, and the gate lines 121 are parallel or perpendicular to the edges of the panels 100 and 200. Since a 45-degree intersection of the tilt directions and transmissive axes of the polarizers results in maximum transmittance, the polarizers may be attached such that the transmissive axes of the polarizers are parallel or perpendicular to the edges of the panels 100 and 200, thereby reducing production cost.

It should be noted that increased resistance of the data lines 171 due to their bent structure may be compensated for by widening them. Further, distortion of the electric field and an increased parasitic capacitance due to wider data line 171 may, in turn, be compensated for by increasing the pixel electrodes size and by thickening organic passivation layer.

In this exemplary embodiment of the present invention, the first pixel electrode 190a is supplied with an image data voltage through the TFT. However, the voltage of the second pixel electrode 190b varies depending on the voltage of the first pixel electrode 190a, since the second pixel electrode 190b is capacitively coupled with it. Therefore, the voltage of the second pixel electrode 190b with reference to the common voltage is always less than that of the first pixel electrode 190a.

As described above, when first and second pixel electrodes 190a and 190b, having different voltages, are disposed in a pixel area, the distortion of the gamma curve decreases by compensation of the two pixel electrodes 190a and 190b.

The reason that the voltage of the second pixel electrode 190b with reference to the common voltage is always less than that of the first pixel electrode 190a will be described with reference to FIG. 5.

FIG. 5 is a circuit diagram of the LCD shown in FIGS. 1, 2, 3 and 4.

In FIG. 5, Clca represents a liquid crystal (LC) capacitance formed between the first pixel electrode 190a and the common electrode 270, and Cst represents a storage capacitance formed between the first pixel electrode 190a and the storage line 131. Clcb represents a liquid crystal (LC) capacitance formed between the second pixel electrode 190b and the common electrode 270, and Ccp represents a coupling capacitance formed between the first pixel electrode 190a and the second pixel electrode 190b.

The voltage Vb of the second pixel electrode 190b with reference to the common voltage, and the voltage Va of the first pixel electrode 190a with reference to the common voltage, are related by the voltage distribution law as follows:
Vb=Va×[Ccp/(Ccp+Clcb)].

Since Ccp/(Ccp+Clcb) is always less than 1, Vb is always less than Va. The capacitance Ccp may be adjusted by overlapping area or distance between the second pixel electrode 190b and the coupling electrode 176. The overlapping area between the second pixel electrode 190b and the coupling electrode 176 may be easily adjusted by changing the width of the coupling electrode 176. The distance between the second pixel electrode 190b and the coupling electrode 176 may be easily adjusted by changing the location of the coupling electrode 176. That is, in the present exemplary embodiment, the coupling electrode 176 is formed on the same layer as the data line 171, but the coupling electrode 176 may be formed on the same layer as the gate line 121, which would increase the distance between the second pixel electrode 190b and the coupling electrode 176.

The shape of the coupling electrode may change in various ways. One example of such a change will be described by the following embodiment.

The following description highlights the distinguishing features of the second exemplary embodiment from the first exemplary embodiment of and other descriptions may be omitted.

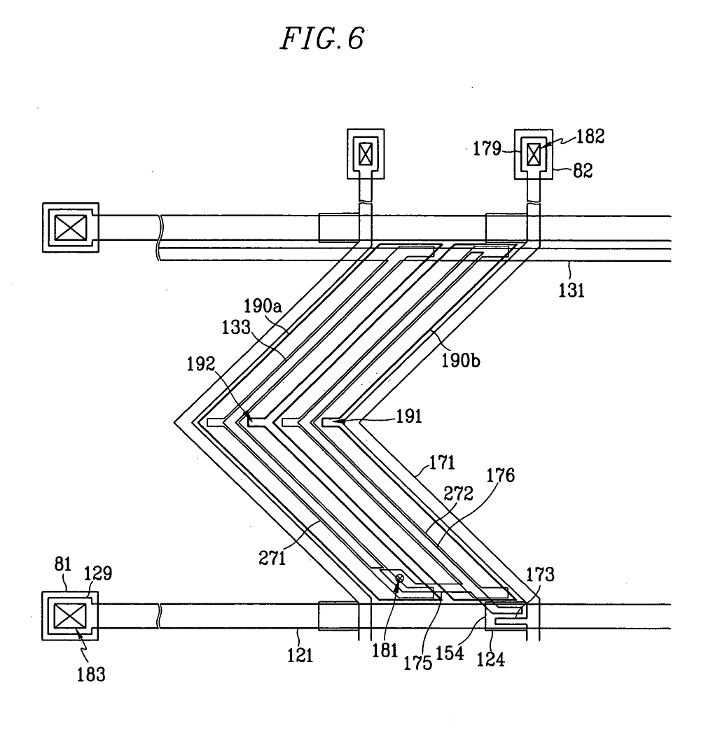

FIG. 6 is a plan view of an LCD according to a second exemplary embodiment of the present invention.

Compared to the first exemplary embodiment, the second exemplary embodiment of FIG. 6 switched the first pixel electrode 190a with the second pixel electrode 190b, and the location of the coupling electrode 176 with that of the storage electrode 133. In other words, the first pixel electrode 190a and the storage electrode 133 are disposed on the left side of a pixel area, and the second pixel electrode 190b and the coupling electrode 176 are disposed on the right side of a pixel area.

Changing the oblique and longitudinal portions of the data lines, as shown in the next exemplary embodiment, may change pixel area shapes.

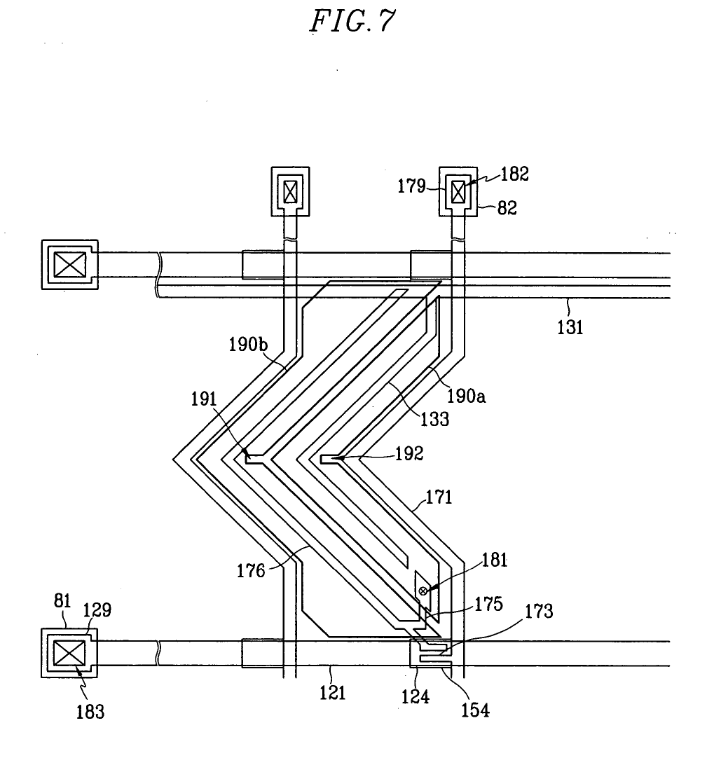

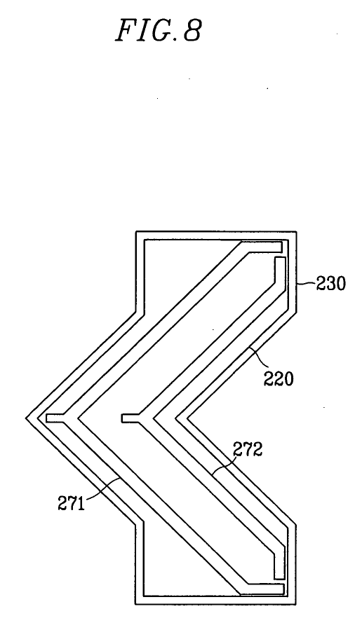

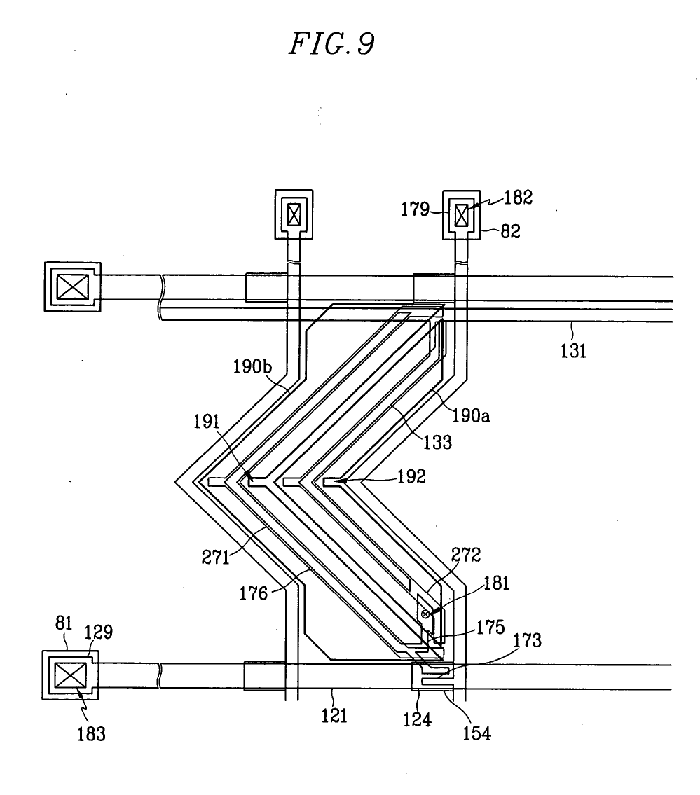

FIG. 7 is a plan view of a thin film transistor array panel for an LCD according to a third exemplary embodiment of the present invention. FIG. 8 is a plan view of a common electrode panel for an LCD according to the third exemplary embodiment of the present invention. FIG. 9 is a plan view of an LCD according to the embodiment shown in FIGS. 7 and 8.

In the third exemplary embodiment of FIGS. 7, 8 and 9, since the data line 171 has more longitudinal portions, a pixel area includes a bent band portion and two rectangular portions that are connected to both ends of the bent band portion. It is preferable that the total length of the rectangular portions is longer than that of the bent band portion.

The shapes of the pixel electrodes 190a and 190b are re-formed corresponding to the new pixel area. The first pixel electrode 190a has two short edges parallel with the data line 171. The second pixel electrode 190b has two short edges parallel with the gate line 121 and neighboring with the gate line 121. The second pixel electrode 190b has two enlarged end portions to fill the whole pixel area.

The storage electrode 133 and the coupling electrode 176 are disposed to correspond with the centerline of the first and second pixel electrodes 190a and 190b, respectively. The common electrode 270 has cutouts 271 and 272 corresponding with the coupling electrode 176 and the storage electrode 133, respectively. Both ends of the cutout 271 are bent and extend a predetermined length in a direction parallel with the gate line 121. Both ends of the cutout 272 are bent and extend a predetermined length in a direction parallel with the data line 171. Centers of the cutouts 271 and 272 also extend a predetermined length and are parallel with the gate lines 121. The centers of the cutouts 271 and 272 extend in an opposite direction from that of the ends of the cutout 271.

The third exemplary embodiment of FIGS. 7 to 9 may diminish a broken display of characters caused by a bent band shape of pixel areas.

In the described embodiments, the semiconductor stripes 151 have substantially the same planar shape as the data lines 171, the drain electrodes 175, and the coupling electrodes 176, as well as the underlying ohmic contacts 161, 165, and 166, except for the projections 154 where TFTs are provided. The projections 154 include some exposed portions, which are not covered with the data lines 171 and the drain electrodes 175, between the source electrodes 173 and the drain electrodes 175.

This structure is achieved by a photo-etching process using a photoresist having a varying thickness to form the intrinsic semiconductor layer 151, 155, and 156, the ohmic contacts 161, 165, and 166, and the layer of data lines 171.

As disclosed in U.S. Pat. Nos. 6,335,276 and 6,531,392, which are hereby incorporated by reference in their entirety, the thin film transistor array panels of the above exemplary embodiments are manufactured by using four photo-masks. The first photo-mask patterns gate lines and storage electrode lines. The second photo-mask patterns the intrinsic semiconductor layer, ohmic contact layer, and data line layer after depositing the gate insulating layer, intrinsic semiconductor layer, ohmic contact layer, and data metal layer. The third photo-mask forms the contact hole in the passivation layer. The fourth photo-mask forms pixel electrodes and contact assistants. The second photo-mask includes light transmissive portions, light blocking portions, and half-transmissive portions that are disposed on channel portions of TFTs during the exposure.

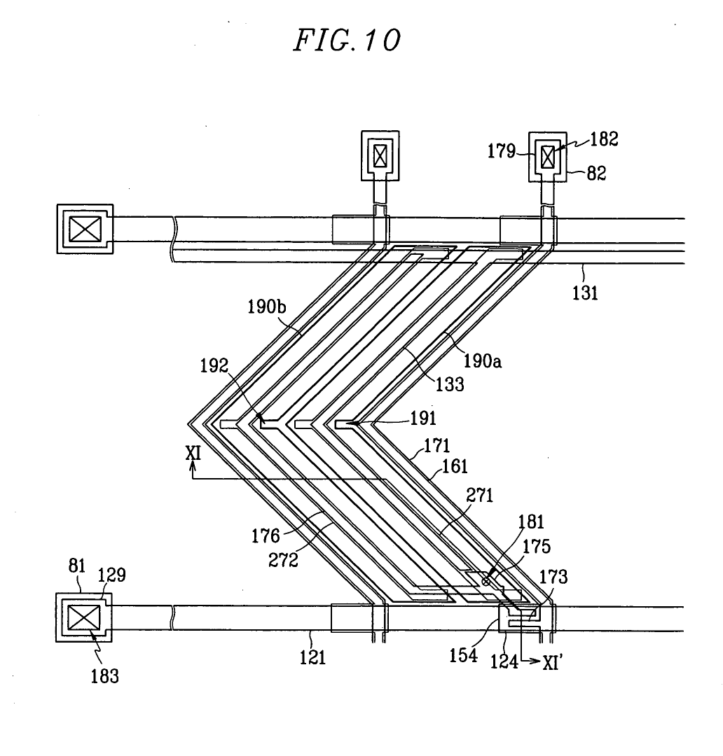

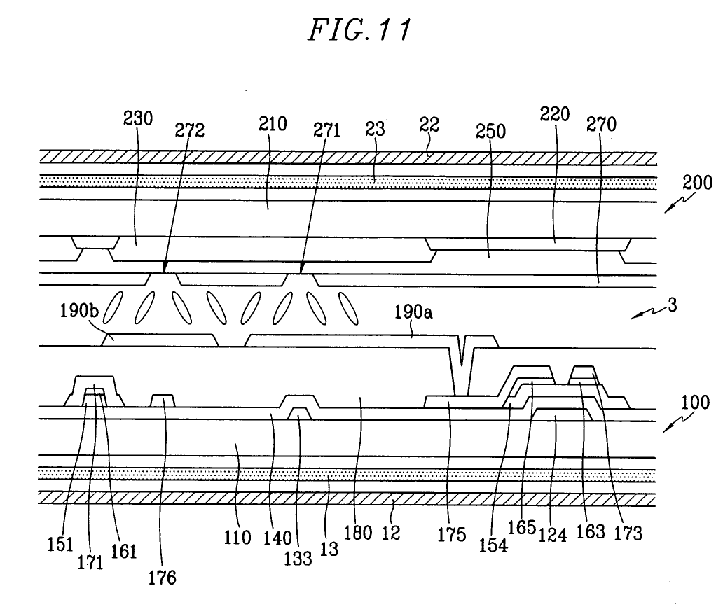

FIG. 10 is a plan view of an LCD according to a fourth exemplary embodiment of the present invention. FIG. 11 is a sectional view of the LCD shown in FIG. 10 taken along the line XI-XI′.

The fourth exemplary embodiment of FIGS. 10 and 11 is distinguished from the first exemplary embodiment by shapes of semiconductor stripes 151, ohmic contacts 161 and 165, and data lines 171, drain electrodes 175, and coupling electrodes 176. In the fourth exemplary embodiment of FIGS. 10 and 11, the planar pattern of the data lines 171, drain electrodes 175, and coupling electrodes 176 differs from that of the semiconductor stripes 151 and ohmic contacts 161 and 165.

In the fourth exemplary embodiment of FIGS. 10 and 11, the data lines 171 are wider than the semiconductor stripes 151 and the ohmic contact stripes 161. Also, there are no semiconductor and ohmic contacts under the coupling electrodes 176, which are formed directly on the gate insulating layer 140. The drain electrode 175 also has a portion formed directly on the gate insulating layer 140.

This structure is formed as follows. The semiconductor stripes 151 and the ohmic contacts 161 and 165 are formed by a photo-etching process. Next, the data lines 171, drain electrodes 175, and coupling electrodes 176 are formed by another photo-etching process. In other words, the structural difference between the first exemplary embodiment and the fourth exemplary embodiment of FIGS. 10 and 11 comes from the different number of photo-etching processes to pattern the semiconductor layer, the ohmic contact layer, and the data line layer. To sum up, one photo-etching process was used to form the semiconductor layer, the ohmic contact layer, and the data line layer of the first exemplary embodiment, but two photo-etching processes were used to form these layers in manufacturing the fourth exemplary embodiment.

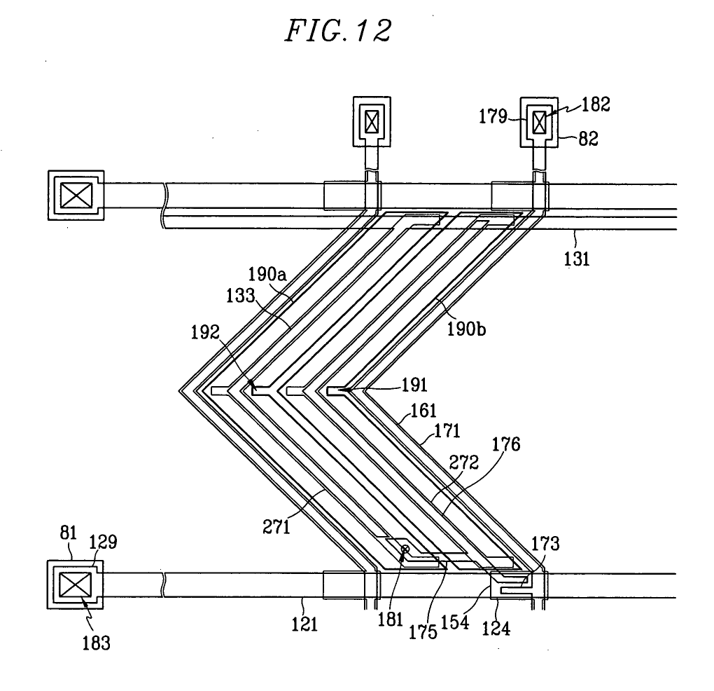

FIG. 12 is a plan view of an LCD according to a fifth exemplary embodiment of the present invention.

The fifth exemplary embodiment of FIG. 12 is distinguished from the second exemplary embodiment of FIG. 6 by the shapes of semiconductor stripes 151, ohmic contacts 161 and 165, and data lines 171, drain electrodes 175, and coupling electrodes 176. In the fifth exemplary embodiment of FIG. 12, the planar pattern of the data lines 171, drain electrodes 175, and coupling electrodes 176 differs from that of the semiconductor stripes 151 and ohmic contacts 161 and 165.

In the fifth exemplary embodiment of FIG. 12, the data lines 171 are wider than the semiconductor stripes 151 and the ohmic contact stripes 161. There are no semiconductor and ohmic contacts under the coupling electrodes 176.

The structural difference between the fifth exemplary embodiment of FIG. 12 and the second exemplary embodiment of FIG. 6 comes from the different number of photo-etching processes used to pattern the semiconductor layer, the ohmic contact layer, and the data line layer. One mask photo-etching process was used to form the semiconductor layer, the ohmic contact layer, and the data line layer of the second exemplary embodiment of FIG. 6, but two mask photo-etching processes were used to form these layers in manufacturing the fifth exemplary embodiment of FIG. 12.

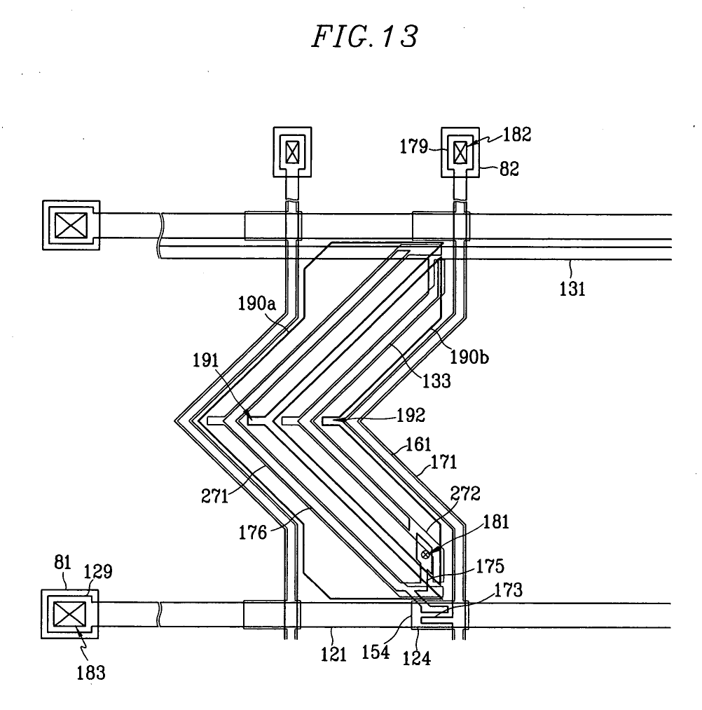

FIG. 13 is a plan view of an LCD according to a sixth exemplary embodiment of the present invention.

The sixth exemplary embodiment of FIG. 13 is distinguished from the third exemplary embodiment of FIGS. 7 to 9 by the shapes of semiconductor stripes 151, ohmic contacts 161 and 165, and data lines 171, drain electrodes 175, and coupling electrodes 176. In the sixth exemplary embodiment of FIG. 13, the planar pattern of the data lines 171, drain electrodes 175, and coupling electrodes 176 differs from that of the semiconductor stripes 151 and ohmic contacts 161 and 165.

In the sixth exemplary embodiment of FIG. 13, the data lines 171 are wider than the semiconductor stripes 151 and the ohmic contact stripes 161. There are no semiconductor and ohmic contacts under the coupling electrodes 176.

That is, the structural difference between the sixth exemplary embodiment of FIG. 13 and the third exemplary embodiment of FIGS. 7 to 9 comes from the different number of photo-etching processes used to pattern the semiconductor layer, the ohmic contact layer, and the data line layer. One mask photo-etching process was used to form the semiconductor layer, the ohmic contact layer, and the data line layer of the third exemplary embodiment of FIG. 7, but two mask photo-etching processes were used to form these layers in manufacturing the sixth exemplary embodiment of FIG. 13.

In the present invention, the first pixel electrode 190a and the second pixel electrode 190b may arranged in many ways. Two examples of such will be described.

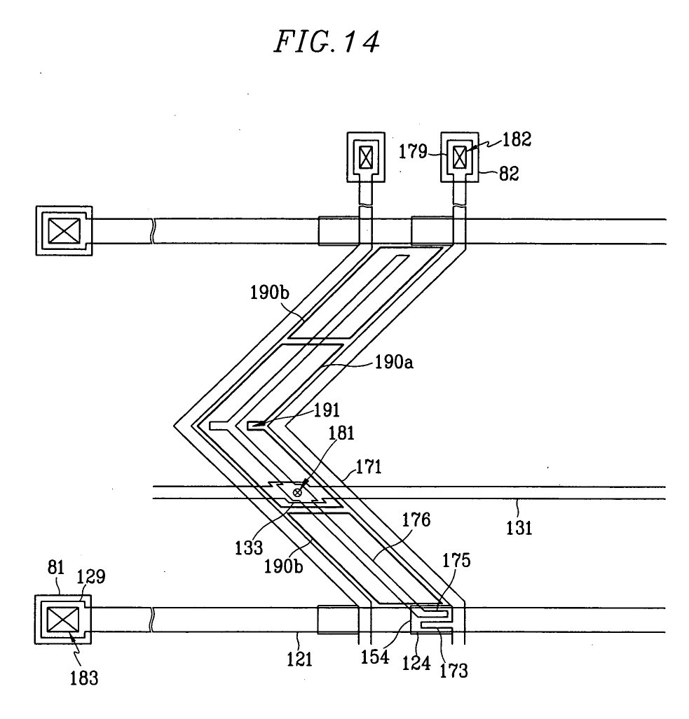

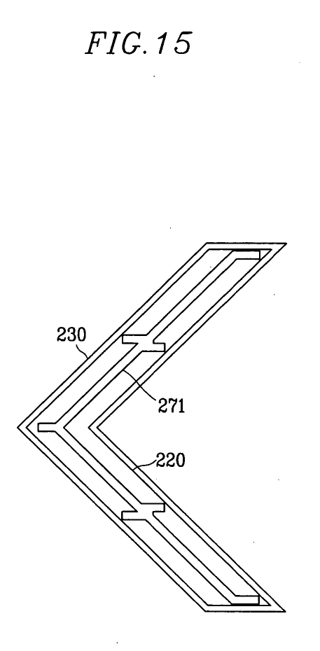

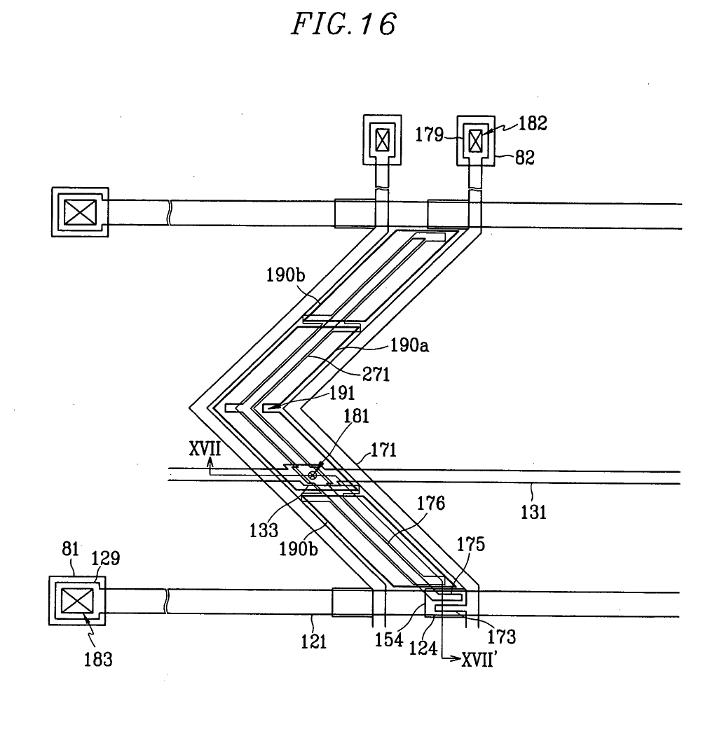

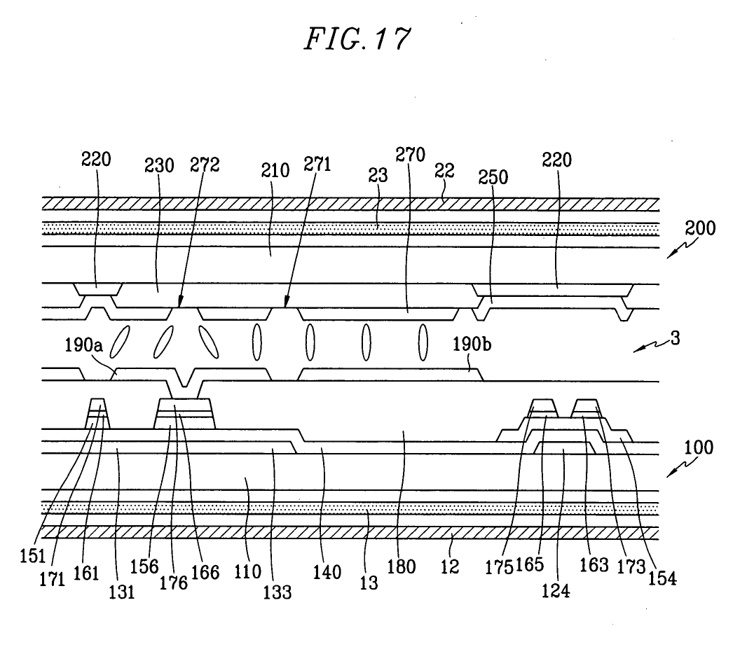

FIG. 14 is a plan view of a thin film transistor array panel for an LCD according to a seventh exemplary embodiment of the present invention. FIG. 15 is a plan view of a common electrode panel for an LCD according to the seventh exemplary embodiment of the present invention. FIG. 16 is a plan view of an LCD according to the embodiments shown in FIGS. 14 and 15. FIG. 17 is a sectional view of the LCD shown in FIG. 16 taken along the line XVII-XVII′.

An LCD according to the seventh exemplary embodiment of FIGS. 14 to 17 includes a TFT array panel 100, a common electrode panel 200, and an LC layer 3 interposed therebetween. The LC layer 3 contains a plurality of LC molecules aligned vertically to surfaces of the panels 100 and 200.

The TFT array panel 100 is now described in detail with reference to FIGS. 14, 16, and 17.

A plurality of gate lines 121 and a plurality of storage electrode lines 131 are formed on an insulating substrate 110.

The gate lines 121, which transmit gate signals, extend substantially in a transverse direction and are separated from each other. A gate line 121 has a plurality of gate electrodes 124 and expansions 129 for connecting to external circuits.

Each storage electrode line 131 extends substantially in the transverse direction and includes a plurality of parallelogram-shaped expansions forming storage electrodes 133.

The gate lines 121 and the storage electrode lines 131 may have a multi-layered structure including a lower film (not shown) and an upper film (not shown). The upper film is preferably made of a low resistivity metal including an Al-containing metal such as Al or an Al alloy for reducing signal delay or voltage drop in the gate lines 121 and the storage electrode lines 131. The lower film is preferably made of a material such as Cr, Mo, or a Mo alloy, which has good contact characteristics with other materials such as ITO and IZO. A good exemplary combination of the lower film material and the upper film material is Cr and an Al-Nd alloy, respectively.

Additionally, the lateral sides of the gate lines 121 and the storage electrode lines 131 are tapered, and the inclination angle of the lateral sides with respect to a surface of the substrate 110 ranges from about 30 to about 80 degrees.

A gate insulating layer 140, preferably made of silicon nitride (SiNx), is formed on the gate lines 121 and the storage electrode lines 131.

A plurality of semiconductor stripes 151, preferably made of hydrogenated amorphous silicon (abbreviated to “a-Si”), are formed on the gate insulating layer 140. Each semiconductor stripe 151 extends substantially in the longitudinal direction and has a plurality of projections 154 branched out toward the gate electrodes 124. An extension 156 is elongated from the projection 154.

Each semiconductor stripe 151 is bent repeatedly and includes a plurality of pairs of oblique portions and a plurality of longitudinal portions. Two oblique portions making a pair are connected to each other to form a chevron, and opposite ends of the pair of oblique portions are connected to respective longitudinal portions. The oblique portions of the semiconductor stripe make an angle of about 45 degrees with the gate lines 121, and the longitudinal portions cross over the gate electrodes 124. The pair of oblique portions are about one to nine times longer than a longitudinal portion. In other words, the oblique portions form about 50 to about 90 percent of the total length of the pair of oblique portions and the longitudinal portion.

The extension 156 includes a drain portion extended obliquely from the projection 154, a pair of oblique portions making an angle of about 45 degrees with the gate lines 121, and a connector connecting the drain portion and an end of the pair of oblique portions.

A plurality of ohmic contact stripes and islands 161 and 165, preferably made of silicide or n+ hydrogenated a-Si heavily doped with n-type impurities, are formed on the semiconductor stripes 151 and projections 154. Each ohmic contact stripe 161 has a plurality of projections 163, and the projections 163 and the ohmic contact islands 165 are located in pairs on the projections 154 of the semiconductor stripes 151.

The edge surfaces of the semiconductor stripes 151 and the ohmic contacts 161, 165, and 166 are tapered and angled, preferably in a range of about 30 to about −80 degrees with respect to a surface of a substrate.

A plurality of data lines 171, a plurality of drain electrodes 175, and a plurality of coupling electrodes 176 are formed on the ohmic contacts 161, 165, and 166, and the gate insulating layer 140.

The data lines 171, which transmit data voltages, extend substantially in the longitudinal direction and intersect the gate lines 121 and the storage electrode lines 131. Each data line 171 is bent repeatedly and includes a plurality of pairs of oblique portions and a plurality of longitudinal portions. Two oblique portions making a pair are connected to each other to form a chevron, and opposite ends of the pair of oblique portions are connected to respective longitudinal portions. The oblique portions of the data lines 171 make about a 45 degree angle with the gate lines 121, and the longitudinal portions cross over the gate electrodes 124. The pair of oblique portions is about one to nine times longer than a longitudinal portion. In other words, the oblique portions form about 50 to about 90 percent of the total length of the pair of oblique portions and the longitudinal portions.

Therefore, pixel areas defined by crossing of the gate line 121 and the data line 171 have a bent stripe shape.

Each data line 171 includes a data pad 179 that is wider than the data line 171 to contact another layer or an external device. A plurality of branches of each data line 171, which project toward the drain electrodes 175, form a plurality of source electrodes 173. Each pair of the source electrodes 173 and the drain electrodes 175 is separated from each other and faces each other a gate electrode 124 there between. A gate electrode 124, a source electrode 173, a is drain electrode 175, and a projection 154 form a TFT having a channel formed in the projection 154, disposed between the source electrode 173 and the drain electrode 175.

A plurality of coupling electrodes 176, which are formed on the same layer and made of the same material as the drain electrode 175, extend from the drain electrodes 175. The first portion of the coupling electrode 176 makes an angle of 135 degrees with the gate line 121, and the second portion of the coupling electrode 176 makes an angle of 45 degrees with the gate line 121. The first and second portions of the coupling electrode 176 are parallel with a pair of oblique portions of the data line 171.

The coupling electrode 176 has an expansion that overlaps the storage electrode 133. This expansion increases storage capacitance and widens the contact area with a first pixel electrode 190a.

The data lines 171, the drain electrodes 175, and the coupling electrodes 176 may have a multi-layered structure including a lower film (not shown) and an upper film (not shown). The upper film is preferably made of a low resistivity metal including an Al-containing metal such as Al or an Al alloy for reducing signal delay or voltage drop in the data lines. The lower film is preferably made of a material such as Cr, Mo, or a Mo alloy, which have good contact characteristics with other materials such as ITO and IZO. A good exemplary combination of the lower film material and the upper film material is Cr and an Al-Nd alloy, respectively.

Additionally, the lateral sides of the data lines 171, the drain electrodes 175, and the coupling electrodes 176 are tapered, and the inclination angle of the lateral sides with respect to a surface of the substrate 110 ranges from about 30 to about 80 degrees.

A passivation layer 180 is formed on the data lines 171, the drain electrodes 175, and the coupling electrodes 176. The passivation layer 180 is preferably made of a flat photosensitive organic material and a low dielectric insulating material having a dielectric constant under 4.0, such as a-Si:C:O or a-Si:O:F formed by plasma enhanced chemical vapor deposition (PECVD), or an inorganic material such as silicon nitride or silicon oxide.

The passivation layer 180 has a plurality of contact holes 181 and 182 exposing the coupling electrode 176 and the data pads 179 of the data lines 171, respectively. The passivation layer 180 and the gate insulating layer 140 have a plurality of contact holes 183 exposing the gate pads 129 of the gate lines 121.

The sidewalls of the contact holes 181, 182, and 183 make an angle of about 30 to about 85 degrees with respect to the surface of the substrate 110, and are stepped.

The contact holes 181, 182, and 183 may have various planar shapes, such as a rectangular shape or a circular shape. The area of each contact hole 181, 182, and 183 is preferably greater than or equal to 0.5 mm×15 μm, and not larger than 2 mm×60 μm.

A plurality of pairs of pixel electrodes 190a and 190b and a plurality of contact assistants 81 and 82 are formed on the passivation layer 180, and they are preferably made of ITO, IZO, or Cr. Contact assistants 81 and 82 are coupled with the gate pads 129 of the gate lines 121 and the data pads 179 of the data lines 171 through the contact holes 182 and 183, respectively.

The first pixel electrode 190a has a bent band shape corresponding to the pixel area shape, , and it has a cutout 191. The second pixel electrode 190b includes two separate parallelograms, and the first pixel electrode 190a is disposed between them. The first pixel electrode 190a and the second pixel electrode 190b occupy approximately the same area.

The first pixel electrode 190a is physically and electrically connected to the coupling electrode 176 through the contact hole 181. The second pixel electrode 190b is physically and electrically floated, but it overlaps the coupling electrode 176 to form a coupling capacitance with the first pixel electrode 190a. Therefore, the voltage of the second pixel electrode 190b depends on the voltage of the first pixel electrode 190a, and the voltage of the second pixel electrode 190b with respect to the common voltage is always less than that of the first pixel electrode 190a. Therefore, applied voltage at the pixel area center is greater than that of both pixel area sides.

In the present embodiment, the coupling electrode 176 transmits the image signal from a thin film transistor to the first pixel electrode 190a, and couples the first pixel electrode 190a and the second pixel electrode 190b.

When a pixel area includes two sub-areas with somewhat different electric fields, lateral visibility may be improved by the mutual compensation in the two sub-areas.

The common electrode panel 200 will be described with respect to FIGS. 15, 16, and 17.

A black matrix 220, which prevents light leakage, is formed on an insulating substrate 210 such as transparent glass.

A plurality of red, green, and blue color filters 230, formed on the black matrix and the substrate 210, extend substantially along the pixel area columns.

An overcoat 250 is formed on the color filters 230 and the black matrix 220, and a common electrode 270, preferably made of a transparent conductive material such as ITO or IZO, is formed on the color filters 230. The common electrode 270 has a plurality of cutouts 271.

The cutouts 271, which act as domain control means, are preferably about 9 μm to about 12 μm wide. When organic protrusions replace the cutouts 271, the organic protrusions are preferably about 5 μm to about 10 μm wide.

A cutout 271 of the common electrode 270 corresponds to the pixel area shape, and it is disposed to divide the first pixel electrode 190a and the second pixel electrode 190b into right and left half portions. Both ends of the cutout 271 are bent and extended a predetermined length in a direction parallel with the gate line 121. Centers of the cutout 271 also extend a predetermined length and are parallel with the gate line 121, but they extend in a direction opposite to that of the ends of the cutout 271. The cutout 271 also has branches that are parallel with the gate line 121 at the 1/4 point and the 3/4 point from one of its ends.

The LCD includes a TFT array panel 100, a color filter array panel 200 facing the TFT array panel 100 and separated by a predetermined gap, and a liquid crystal layer 3 filled in the predetermined gap.

The LC molecules in the LC layer 3 are aligned such that their long axes are vertical to the surfaces of the panels 100 and 200 when there is no electric field. The liquid crystal layer 3 has negative dielectric anisotropy.

The thin film transistor array panel 100 and the color filter array panel 200 are assembled to make the pixel electrodes 190a and 190b precisely correspond to the color filter 230. When the two panels 100 and 200 are assembled, pixel areas are divided into a plurality of sub-areas by the edges of the first and second pixel electrodes 190a and 190b and the cutouts 271. If the liquid crystal region on each sub-area is called a domain, the cutouts 271 divide a pixel region into 4 domains.

The domains have two parallel longest edges, and are preferably about 10 μm to about 30 μm wide.

A pair of polarizers 12 and 22 is formed on the outer surfaces of the panels 100 and 200 such that their transmissive axes are crossed, and one of the transmissive axes is parallel to the gate lines 121.

The LCD may further include at least one retardation film (e.g., an optical element that produces, for example, full, half, or quarter wave phase changes of polarized light) for compensating for the retardation of the LC layer 3.

A primary electric field, substantially perpendicular to the surfaces of the panels 100 and 200, is generated by applying a common voltage to the common electrode 270 and a data voltage to the pixel electrodes 190a and 190b. The LC molecules tend to change their orientations in response to the electric field such that their long axes are perpendicular to the field direction.

The cutouts 271 and the edges of the pixel electrodes 190a and 190b distort the primary electric field to have a horizontal component, which determines the tilt directions of the LC molecules. The horizontal component of the primary electric field adopts four different orientations, thereby forming four domains in the LC layer 3 where LC molecules are titled in different directions. The horizontal component is perpendicular to the edges of the cutouts 271, the edges of the pixel electrodes 190a and 190b. Accordingly, four domains having different tilt directions are formed in the LC layer 3. Alternatively, a plurality of protrusions (not shown) may be used in place of the cutouts 271 since protrusions may also control the tilt directions of the LC molecules.

A secondary electric field, formed by the voltage difference between the pixel electrodes 190a and 190b, is perpendicular to the edges of the cutout 271. Accordingly, the secondary electric field direction coincides with that of the horizontal component of the primary electric field. Consequently, the secondary electric field enhances the tilt directions of the LC molecules.

Since the LCD performs inversion (i.e., inverting the polarity of an applied voltage) such as dot inversion, column inversion, etc., the secondary electric field may be attained by supplying an adjacent pixel electrode with a data voltage having an opposite polarity of the common voltage. As a result, the secondary electric field direction may be the same as the direction of the horizontal component of the primary electric field. Thus, domain stability may be enhanced by a secondary electric field between the adjacent pixel electrodes.

The tilt directions of all the domains form an angle of about 45 degrees with the gate lines 121, and the gate lines 121 are parallel to or perpendicular to the edges of the panels 100 and 200. Since a 45-degree intersection of the tilt directions and transmissive axes of the polarizers results in maximum transmittance, the polarizers 12 and 22 may be attached such that their transmissive axes are parallel or perpendicular to the edges of the panels 100 and 200, thereby reducing production cost.

As described above, when two pixel electrodes 190a and 190b having different voltages are disposed in a pixel area, the distortion of the gamma curve decreases by compensation of the two pixel electrodes 190a and 190b.

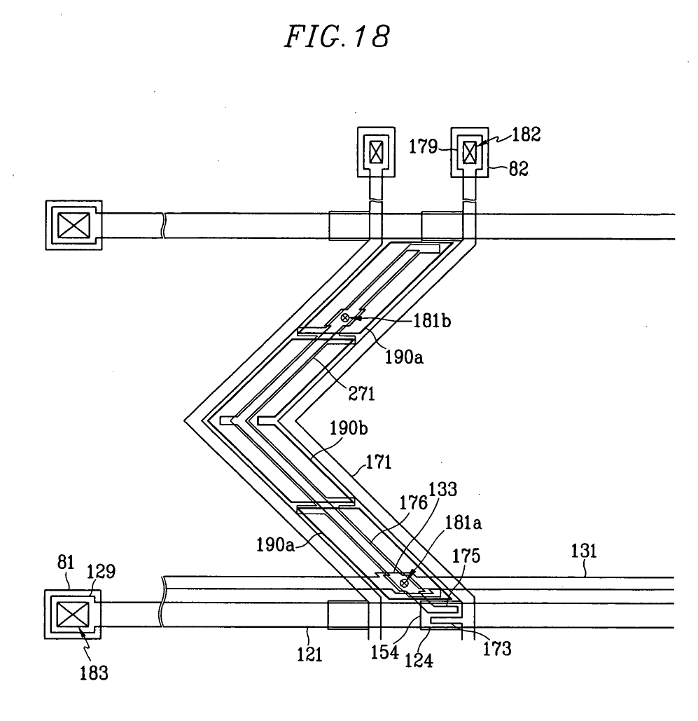

FIG. 18 is a plan view of an LCD according to an eighth exemplary embodiment of the present invention.

Compared to the seventh exemplary embodiment of FIGS. 14 to 17, the eighth exemplary embodiment of FIG. 18 switched the first pixel electrode 190a with the second pixel electrode 190b, and moved the storage electrode line 131 and the expansion of the coupling electrode 176. That is, the first pixel electrode 190a has two separate portions shaped as parallelograms, and the second pixel electrode 190b, which has the bent band shape, is disposed between them. The coupling electrode 176 has an expansion coupled with each portion of the first pixel electrode 190a.

The embodiments of FIGS. 14 to 17 and FIG. 18 show TFT array panels manufactured through four mask photo-etching processes. However, it will be easy to understand to those skilled in the art that the ideas of the embodiments of FIGS. 14 to 17 and FIG. 18 may be adapted to TFT array panels manufactured through five mask photo-etching processes.

In the above described embodiments, cutouts are formed in the common electrode and may be used as a domain control means. However, organic protrusions may be formed on the common electrode instead of the cutouts. When organic protrusions are used as a domain control means, their planar pattern may be the same as that of the cutouts.

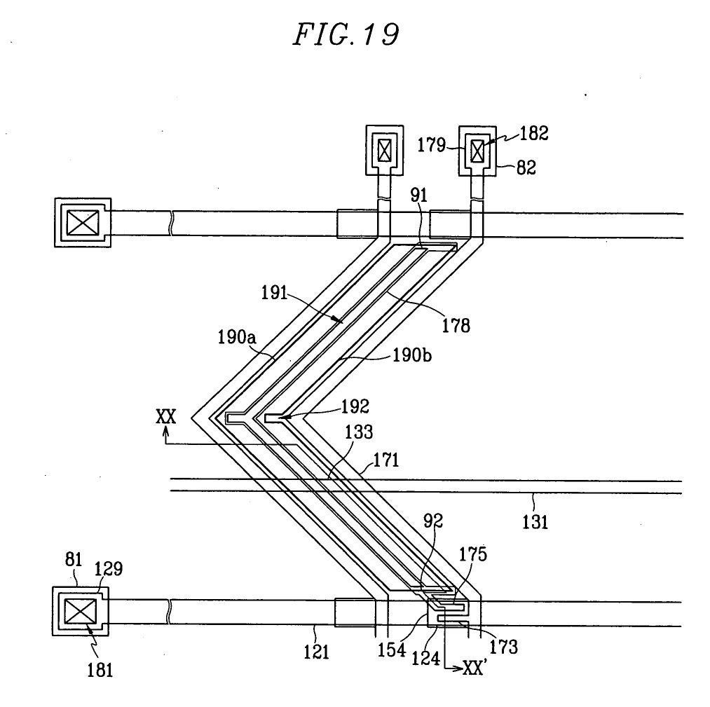

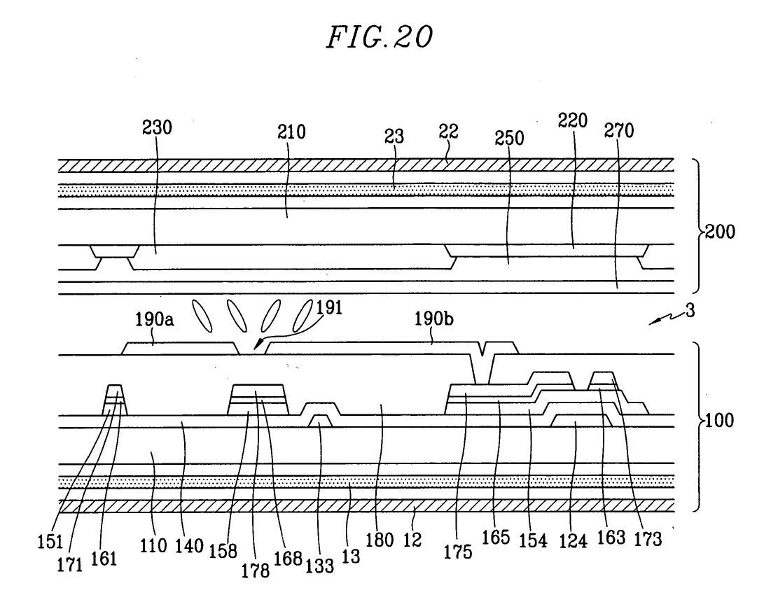

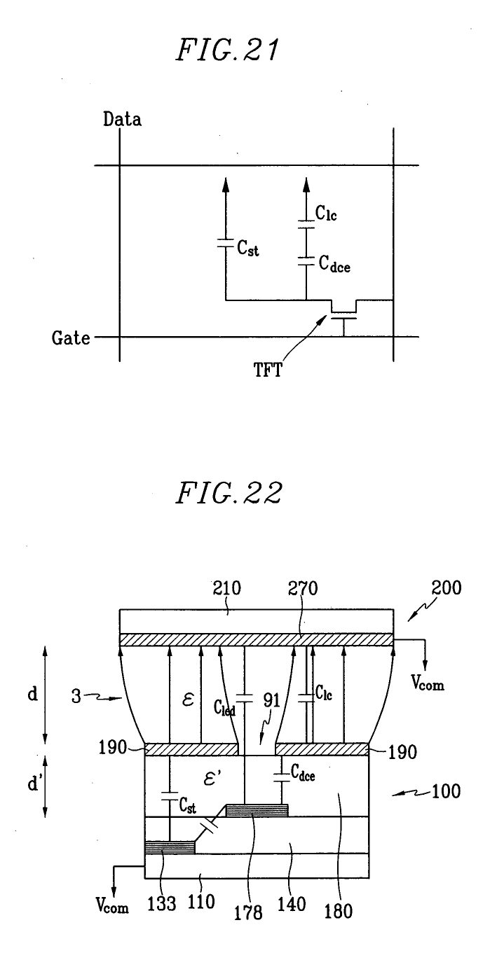

FIG. 19 is a plan view of an LCD according to a ninth exemplary embodiment of the present invention; FIG. 20 is a sectional view of the LCD shown in FIG. 19 taken along the line XX-XX′; FIG. 21 is a circuit diagram of the LCD shown in FIGS. 19 and 20; and FIG. 22 is a conceptual diagram of the LCD shown in FIGS. 19 and 20.

An LCD according to a ninth exemplary embodiment of the present invention includes a TFT array panel 100, a common electrode panel 200, and an LC layer 3 interposed therebetween. The LC layer 3 contains a plurality of LC molecules aligned vertically to surfaces of the panels 100 and 200.

The TFT array panel 100 will now be described in detail with reference to FIGS. 19 and 20.

A plurality of gate lines 121 and a plurality of storage electrode lines 131 are formed on an insulating substrate 110.

The gate lines 121, which transmit gate signals, extend substantially in a transverse direction and are separated from each other. The gate lines 121 have a plurality of gate electrodes 124 and expansions 129 for connecting to external circuits.

Each storage electrode line 131 extends substantially in the transverse direction, and includes a plurality of storage electrodes 133. The storage electrode 133 includes a pair of oblique portions making an angle of about 45 degrees with the storage line 131. Two oblique portions making a pair make an angle about 90 degrees with each other. The storage electrode lines 131 are supplied with a predetermined voltage such as a common voltage, which is applied to a common electrode 270 on the other panel 200 of the LCD.

The gate lines 121 and the storage electrode lines 131 may have a multi-layered structure including a lower film (not shown) and an upper film (not shown). The upper film is preferably made of a low resistivity metal including an Al-containing metal such as Al or an Al alloy for reducing signal delay or voltage drop in the gate lines 121 and the storage electrode lines 131. The lower film is preferably made of a material such as Cr, Mo, or an Mo alloy, which have good contact characteristics with other materials such as ITO or IZO. A good exemplary combination of the lower film material and the upper film material is Cr and an Al-Nd alloy, respectively.

Additionally, the lateral sides of the gate lines 121 and the storage electrode lines 131 are tapered, and the inclination angle of the lateral sides with respect to a surface of the substrate 110 ranges from about 30 to about 80 degrees.

A gate insulating layer 140, preferably made of silicon nitride (SiNx), is formed on the gate lines 121 and the storage electrode lines 131.

A plurality of semiconductor stripes 151, preferably made of hydrogenated amorphous silicon (abbreviated to “a-Si”), are formed on the gate insulating layer 140. Each semiconductor stripe 151 extends substantially in the longitudinal direction and has a plurality of projections 154 branched out toward the gate electrodes 124. An extension 158 is elongated from the projection 154.

Each semiconductor stripe 151 is bent repeatedly and includes a plurality of pairs of oblique portions and a plurality of longitudinal portions. An oblique portion pair forms a chevron, and opposite ends of the pair are connected to the longitudinal portions. The oblique portions make an angle of about 45 degrees with the gate lines 121, and the longitudinal portions cross over the gate electrodes 124. The pair of oblique portions is about one to nine times longer than the longitudinal portion. In other words, the oblique portions form about 50 to about 90 percent of the total length of the pair of oblique portions and the longitudinal portions.

The extension 158 includes a chevron portion extending from the projection 154 and parallel with the pair of oblique portions of the semiconductor stripe 151, a pair of bent ends connected to ends of the chevron portion and parallel with the gate line, and a center projection extending from the bent point of the chevron portion and parallel with the gate line, but in an opposite direction to that of its bent ends.

A plurality of ohmic contact stripes 161 and 163, and islands 165 and 168, preferably made of silicide or n+ hydrogenated a-Si heavily doped with n-type impurities, are formed on the semiconductor stripes 151, extensions 158, and projections 154. Each ohmic contact stripe 161 has a plurality of projections 163, and the projections 163 and the ohmic contact islands 165 are located in pairs on the projections 154 of the semiconductor stripes 151.

A plurality of data lines 171, a plurality of drain electrodes 175, and a plurality of direction control electrodes 178 are formed on the ohmic contacts 161, 165, and 168 and the gate insulating layer 140, respectively.

The data lines 171, which transmit data voltages, extend substantially in the longitudinal direction and intersect the gate lines 121 and the storage electrode lines 131. Each data line 171 is bent repeatedly and includes a plurality of pairs of oblique portions and a plurality of longitudinal portions. An oblique portion pair forms a chevron, and opposite ends of the pair of oblique portions are connected to respective longitudinal portions. The oblique portions of the data lines 171 make an angle of about 30 to 60 degrees (preferably 45 degrees) with the gate lines 121, and the longitudinal portions cross over the gate electrodes 124. The length of a pair of oblique portions is about one to nine times the length of a longitudinal portion. In other words, the oblique portions form about 50-90 percent of the total length of the pair of oblique portions and the longitudinal portions.

Therefore, crossings of the gate line 121 and the data line 171 define bent stripe shaped pixel areas.

Each data line 171 includes a data pad 179 wider than the data line, to contact another layer or an external device. A plurality of branches of each data line 171, which project toward the drain electrodes 175, form a plurality of source electrodes 173. Each pair of the source electrodes 173 and the drain electrodes 175 is separated from each other and faces each other with a gate electrode 124 there between. A gate electrode 124, a source electrode 173, a drain electrode 175, and a projection 154 form a TFT having a channel formed in the projection 154, disposed between the source electrode 173 and the drain electrode 175.

The direction control electrode 178 extends from the drain electrode 175 and bends to be parallel with the pair of oblique portions of the data line 171. A first portion of the direction control electrode 178 makes an angle of 120 degrees to 150 degrees (preferably 135 degrees) with the gate line 121, and a second portion makes an angle of 30 degrees to 60 degrees (preferably 45 degrees) with the gate line 121.

The direction control electrode 178 overlaps with a cutout 191, and it is wider than the cutout 191.

The direction control electrode 178 is capacitively coupled with a pixel electrode.

The data lines 171, the drain electrodes 175, and the direction control electrodes 178 may have a multi-layered structure including a lower film (not shown) and an upper film (not shown). The upper film is preferably made of a low resistivity metal including an Al-containing metal such as Al or an Al alloy for reducing signal delay or voltage drop in the data lines. The lower film is preferably made of a material such as Cr, Mo, or an Mo alloy, which have good contact characteristics with other materials such as ITO and IZO. A good exemplary combination of the lower film material and the upper film material is Cr and an Al-Nd alloy, respectively.

Additionally, the lateral sides of the data lines 171, the drain electrodes 175, and the direction control electrodes 178 are tapered, and the inclination angle of the lateral sides with respect to a surface of the substrate 110 ranges from about 30 to about 80 degrees.

A passivation layer 180 is formed on the data lines 171, the drain electrodes 175, and the direction control electrodes 178. The passivation layer 180 is preferably made of a flat photosensitive organic material and a low dielectric insulating material having a dielectric constant under 4.0, such as a-Si:C:O and a-Si:O:F formed by plasma enhanced chemical vapor deposition (PECVD), or an inorganic material such as silicon nitride or silicon oxide.

The passivation layer 180 has a plurality of contact holes 182 exposing the expansions 179 of the data lines 171. The passivation layer 180 and the gate insulating layer 140 have a plurality of contact holes 181 exposing the expansions 129 of the gate lines 121.

The sidewalls of the contact holes 181 and 182 make an angle of about 30 to about 85 degrees with respect to the surface of the substrate 110, and are stepped.

The contact holes 181 and 182 may have various planar shapes, such as a rectangular shape and a circular shape. The area of each contact hole 181 and 182 is preferably greater than or equal to 0.5 mm×15 μm, and not larger than 2 mm×60 μm.

A plurality of pairs of pixel electrodes 190a and 190b and a plurality of contact assistants 81 and 82 are formed on the passivation layer 180, and are preferably made of ITO, IZO, or Cr.

The cutout 191 defines the first pixel electrode 190a and the second pixel electrode 190b, which have a bent stripe shape corresponding to the pixel area. Also, the first pixel electrode 190a and the second pixel electrode 190b have substantially the same shape, and they divide the pixel area into a left area and a right area, which they respectively occupy. Therefore, the first pixel electrode 190a may correspond to the second pixel electrode 190b by a parallel movement along the gate lines 121.

Connectors 91 and 92 connect the first pixel electrode 190a and the second pixel electrode 190b. The second pixel electrode 190b has a cutout 192 that divides it into lower and upper portions.

The first and second pixel electrodes 190a and 190b are not physically connected to the drain electrodes 175, but they are capacitively coupled with the direction control electrode 178, which is connected to the drain electrode 175. Therefore, the voltages of the first and second pixel electrode 190a and 190b depend on the voltage of the direction control electrode 178. In this case, the voltage of the direction control electrode 178 is always greater than that of the pixel electrodes 190a and 190b. This relationship is described below with reference to FIGS. 21 and 22.

The common electrode panel 200 will be described with respect to FIGS. 19 to 20.

A black matrix 220, which prevents light leakage, is formed on an insulating substrate 210 such as transparent glass.

A plurality of red, green, and blue color filters 230, formed on the black matrix 220 and the substrate 210, extend substantially along the pixel area columns.

An overcoat 250 is formed on the color filters 230 and the black matrix 220, and a common electrode 270, preferably made of a transparent conductive material such as ITO or IZO, is formed on the overcoat 250.

The LCD includes a TFT array panel 100, a color filter array panel 200 facing the TFT array panel 100 and separated therefrom by a predetermined gap, and a liquid crystal layer 3 filled in the predetermined gap.

The LC molecules in the LC layer 3 are aligned such that their long axes are vertical to the surfaces of the panels 100 and 200 when there is no electric field. The liquid crystal layer 3 has negative dielectric anisotropy.

The thin film transistor array panel 100 and the color filter array panel 200 are assembled to make the pixel electrodes 190a and 190b precisely correspond to the color filter 230. When the two panels 100 and 200 are assembled, pixel areas are divided into a plurality of sub-areas by the edges of the first and second pixel electrodes 190a and 190b and the cutouts 191. If the liquid crystal region on each sub-area is called a domain, the cutout 191 divides the is pixel region into 4 domains.

The domains have two parallel longest edges, and are preferably about 10 to about 30 μm wide.

A pair of polarizers 12 and 22 is formed on the outer surfaces of the panels 100 and 200 such that their transmissive axes are crossed, and one of their transmissive axes is parallel to the gate lines 121.

The LCD may further include at least one retardation film (e.g., an optical element that produces, for example, full, half, or quarter wave phase changes of polarized light) for compensating for the retardation of the LC layer 3.

Voltages applied to the common electrode 270 and the pixel electrodes 190a and 190b generate a primary electric field that is substantially perpendicular to the surfaces of the panels 100 and 200. The LC molecules tend to change their orientations in response to the electric field such that their long axes are perpendicular to the field direction.

The cutout 191 and the edges of the pixel electrodes 190a and 190b distort the primary electric field to have a horizontal component, which determines the tilt directions of the LC molecules. The horizontal component is perpendicular to the edges of the cutout 191, the first pixel electrode 190a and the second pixel electrode 190b. Consequently, the horizontal component of the primary electric field adopts four different orientations, thereby forming four domains in the LC layer 3 with different LC molecule tilt directions.

A voltage difference between pixel electrodes 190a and 190b generates a secondary electric field that is perpendicular to each edge of the cutout 191. Accordingly, the secondary electric field direction coincides with that of the horizontal component of the primary electric field. Consequently, the secondary electric field between the pixel electrodes 190a and 190b enhances the tilt directions of the LC molecules.

Since the LCD performs inversion (i.e., inverting the polarity of an applied voltage) such as dot inversion, column inversion, etc., a secondary electric field is attained by supplying an adjacent pixel electrode with a data voltage having an opposite polarity of the common voltage. As a result, the secondary electric field direction is the same direction as the horizontal component of the primary electric field. Thus, the secondary electric field may enhance domain stability.

The tilt directions of all the domains form an angle of about 45 degrees with the gate lines 121, and the gate lines 121 are parallel or perpendicular to the edges of the panels 100 and 200. Since a 45-degree intersection of the tilt directions and transmissive axes of the polarizers results in maximum transmittance, the polarizers 12 and 22 may be attached such that their transmissive axes are parallel or perpendicular to the edges of the panels 100 and 200, thereby reducing production cost.

It should be noted that increased resistance of the data lines 171, due to their bent structure, may be compensated for by widening them. Further, distortion of the electric field and an increased parasitic capacitance due to increases in width of the data lines 171 can, in turn, be compensated for by increasing the pixel electrodes size and by thick organic passivation layer.

In the ninth exemplary embodiment of the present invention, the voltages of the pixel electrodes 190a and 190b depend on the voltage of the direction control electrode 178, since the pixel electrodes 190a and 190b are capacitively coupled with the direction control electrode 178.

The voltages of the pixel electrodes 190a and 190b are always less than that of the direction control electrode 178. Therefore, the direction control electrode 178 may enhance the LC array stability.

The reason that the voltage of the direction control electrode 178 always exceeds that of the pixel electrodes 190a and 190b will be described with reference to FIG. 21 and FIG. 22.

As shown in FIGS. 21 and 22, the direction control electrode 178 is capacitively coupled with the pixel electrodes 190a and 190b. Cdce represents a capacitance between the direction control electrode 178 and the pixel electrodes 190a and 190b. Clc represents a capacitance formed by the pixel electrodes 190a and 190b and the common electrode 270. Cst represents a capacitance formed by the pixel electrodes 190a and 190b and the storage electrode 133.

Clcd represents a capacitance formed by the direction control electrode 178 and the common electrode 270. Cstd represents a capacitance formed by the direction control electrode 178 and the storage electrode 133.

As shown in FIG. 22, when a data voltage Vdce is applied to the direction control electrode 178, the pixel electrodes 190a and 190b have a voltage Vp less than Vdce due to a voltage distribution between Cdce and Clc. That is,
Vp=Vdce*Cdce/(Cdce+Clc). (1)

Since Cdce/(Cdce+Clc) is always less than 1, Vp is less than Vdce.

When Vdce represents a voltage of the direction control electrode 178, Vp represents a voltage of the pixel electrodes 190a and 190b, ε represents a LC layer 3 dielectric constant, d represents a distance between the pixel electrodes 190a and 190b and the common electrode 270, ε′ represents a passivation layer 180 dielectric constant, and d′ represents a distance between the pixel electrodes 190a and 190b and the direction control electrode 178, the following formula will be satisfied such that the direction control electrode 178 plays a role of enhancing LC array stability.
Vdce>Vp(1+εd′/ε′d). (2)

According to the Formula (1), since Cdce effects Vp, the formula (2) may be satisfied by adjusting Cdce. Cdce may be adjusted by varying an overlapping area, or a distance between, the direction control electrode 178 and the pixel electrodes 190a and 190b. The overlapping area may be easily varied by adjusting the direction control electrode 178 width, and the distance between them may be varied by changing the direction control electrode 178 location. That is, in the present exemplary embodiment, the direction control electrode 178 is formed on the same layer as the data line 171, but the direction control electrode 178 may alternatively be formed on the same layer as the gate line 121, which would increase the distance between the direction control electrode 178 and the pixel electrodes 190a and 190b.

The direction control electrode 178 may be arranged in various ways. One such example will be described.

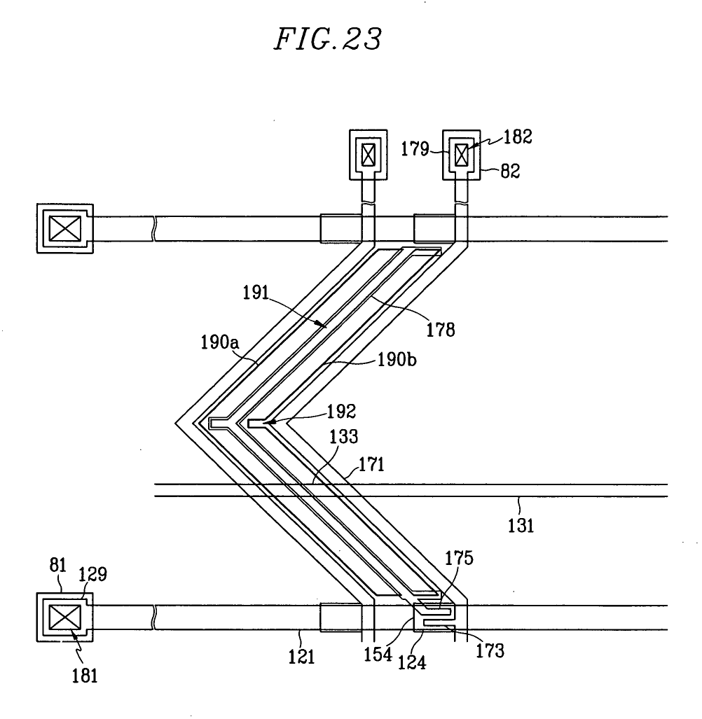

FIG. 23 is a plan view of an LCD according to a tenth exemplary embodiment of the present invention.

Comparing the tenth exemplary embodiment of FIG. 23 to the ninth exemplary embodiment of FIGS. 19 and 20, differences include the cutout 191 completely separates the first pixel electrode 190a and the second pixel electrode 190b. The first pixel electrode 190a is separated by a predetermined distance from the second pixel electrode 190b. The direction control electrode 178 overlaps, and is capacitively coupled with, the first pixel electrode 190a and the second pixel electrode 190b.

The first pixel electrode 190a and the second pixel electrode 190b have substantially the same shape, dividing a pixel area into a left area and a right area, and occupying they occupy those areas, respectively. Therefore, the first pixel electrode 190a may correspond to the second pixel electrode 190b by a parallel movement along the gate lines 121.

Coupling capacitances between the direction control electrode 178 and the first and second pixel electrodes 190a and 190b may be adjusted so that the voltages of the first and second pixel electrodes 190a and 190b are less than the voltage of the direction control electrode 178, by a value of at least Vp (εd′/ε′d).

The voltage of the first pixel electrode 190a preferably differs from that of the second pixel electrode 190b by a predetermined value. This voltage difference may be achieved by forming unequal overlap areas between the direction control electrode 178 and the first pixel electrode 190a and between the direction control electrode 178 and the second pixel electrode 190b.

When a pixel area includes two sub-areas with somewhat different electric fields, lateral visibility may be improved by the mutual compensation in the two sub-areas.

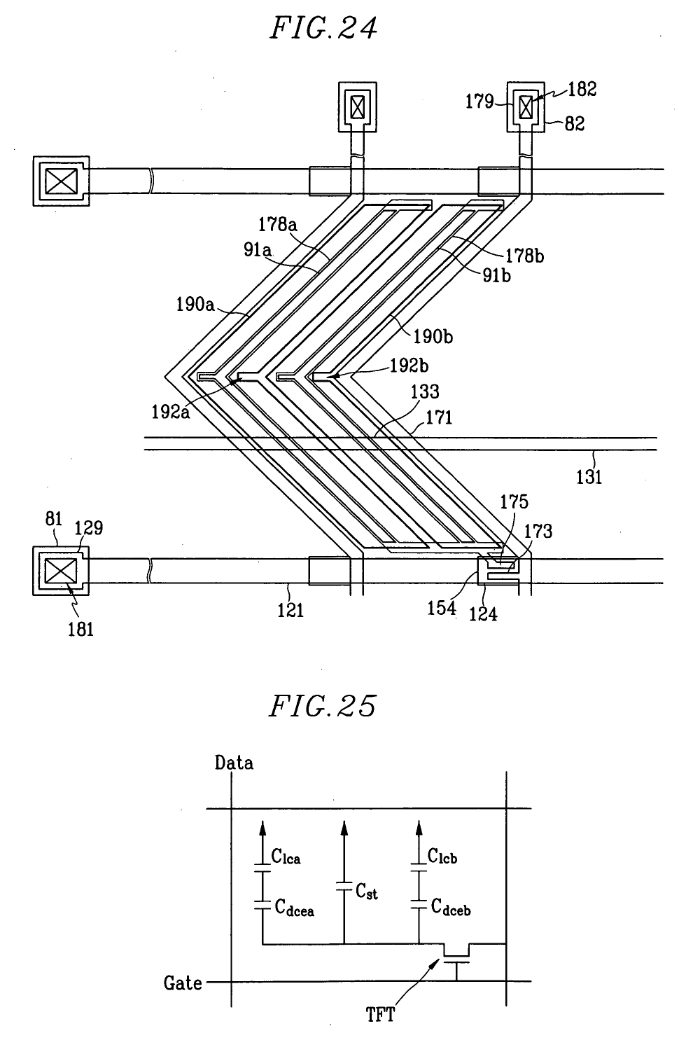

FIG. 24 is a plan view of an LCD according to an eleventh exemplary embodiment of the present invention, and FIG. 25 is a circuit diagram of the LCD shown in FIG. 24.

As shown in FIG. 24, a first pixel electrode 190a and a second pixel electrode 190b are formed in a pixel area, and they are separated by a predetermined distance and are electrically floated.

They have substantially the same shape, they divide a pixel area into a left area and a right area, and they occupy those areas, respectively. Therefore, the first pixel electrode 190a may correspond to the second pixel electrode 190b by a parallel movement along the gate lines 121.

The first pixel electrode 190a and the second pixel electrode 190b have chevron shaped cutouts 191a and 191b, which divide the pixel electrodes into right and left portions. Cutouts 192a and 192b, of the first and second pixel electrodes 190a and 190b, respectively, divide the pixel electrodes into lower and upper portions.

A first direction control electrode 178a and a second direction control electrode 178b are formed in a pixel area. The first direction control electrode 178a overlaps the cutout 191a, and the second direction control electrode 178b overlaps the cutout 191b. The first and second direction control electrodes 178a and 178b are connected to the drain electrode 175.

The voltage of the first pixel electrode 190a is adjusted to be less than the voltage of the first direction control electrode 178a by a value of at least Vpa (εd′/ε′d). The voltage of the second pixel electrode 190b is adjusted to be less than the voltage of the second direction control electrode 178b by a value of at least Vpb (εd′/ε′d).

Vpa represents the voltage of the first pixel electrode 190a, and Vpb represents the voltage of the second pixel electrode 190b. ε represents a dielectric constant of the LC layer 3, d represents a distance between the pixel electrodes 190a and 190b and the common electrode 270, ε′ represents a dielectric constant of the passivation layer 180, and d′ represents a distance between the pixel electrodes 190a and 190b and the direction control electrodes 178a and 178b.

The first pixel electrode 190a voltage preferably differs from that of the second pixel electrode 190b by a predetermined value. This voltage difference may be achieved by having different overlap areas between the first direction control electrode 178a and the first pixel electrode 190a, and between the second direction control electrode 178b and the second pixel electrode 190b.

As described above, when a pixel area includes two sub-areas with somewhat different electric fields, lateral visibility may be improved by the mutual compensation in the two sub-areas.

The voltage Vpa of the first pixel electrode 190a and the voltage Vpb of the second pixel electrode 190b are determined as follows, by the voltage distribution law:
Vpa=Vdcea*Cdcea/(Cdcea+Clca) (3)
Vpb=Vdceb*Cdceb/(Cdceb+Clcb) (4).

According to the formulas (3) and (4), the voltages of the first and second pixel electrodes 190a and 190b may be controlled by adjusting Cdcea and Cdceb. Cdcea represents the capacitance formed between the first direction control electrode 178a and the first pixel electrode 190a, and Cdceb represents the capacitance formed between the second direction control electrode 178b and the second pixel electrode 190b.

Clca, which represents the capacitance between the first pixel electrode 190a and the common electrode 270, and Clcb, which represents the capacitance between the second pixel electrode 190b and the common electrode 270, may also be adjusted to control Vpa and Vpb. Clca and Clcb may be adjusted by varying an overlapping area between the first and second pixel electrodes 190a and 190b and the common electrode 270.

It is preferable, for enhancing light transmittance, that Vpa and Vpb approach Vdcea and Vdceb.

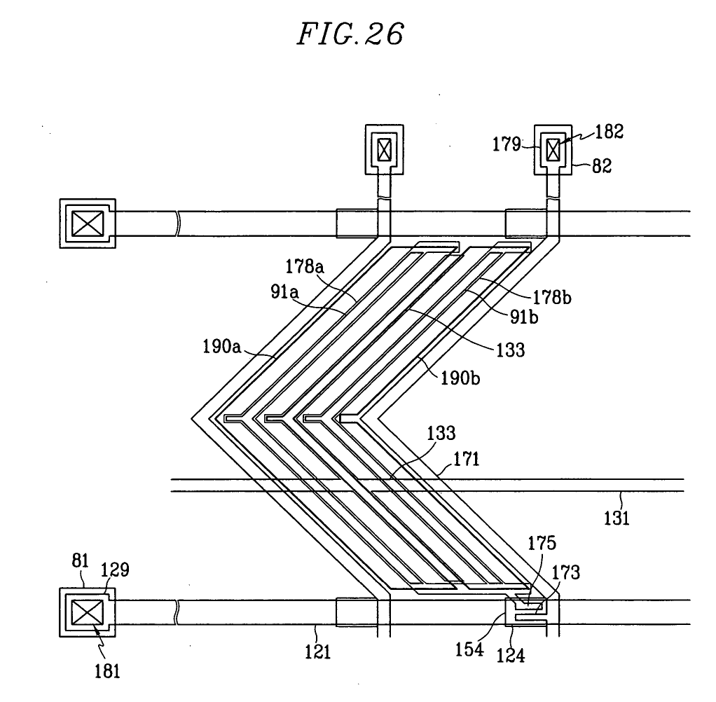

FIG. 26 is a plan view of an LCD according to a twelfth exemplary embodiment of the present invention.

Comparing the twelfth exemplary embodiment of FIG. 26 to the eleventh exemplary embodiment of FIG. 24, the twelfth exemplary embodiment of FIG. 26 further includes a plurality of storage electrodes 133 formed between the first pixel electrode 190a and the second pixel electrode 190b. Disposing the storage electrode 133 between the first pixel electrode 190a and the second pixel electrode 190b enhances a fringe field around the boundary of the first and second pixel electrodes 190a and 190b, which may enhance domain stability.

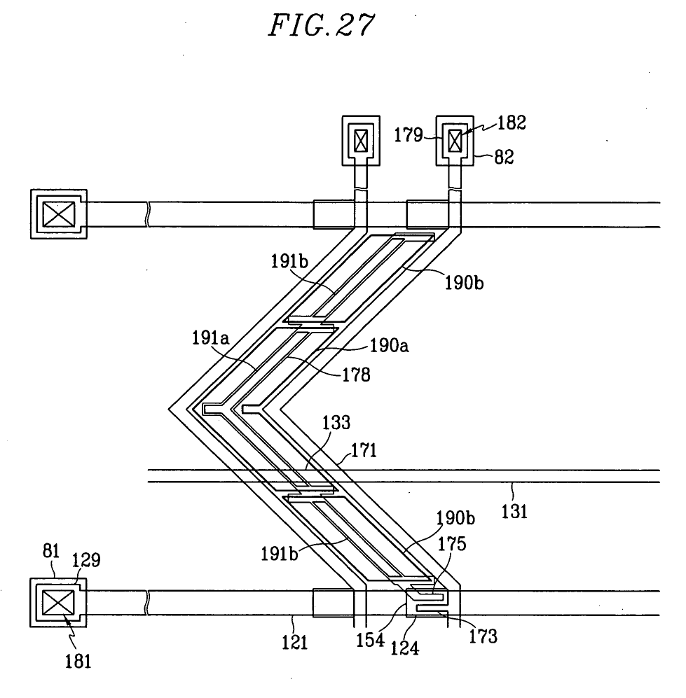

FIG. 27 is a plan view of an LCD according to a thirteenth exemplary embodiment of the present invention. FIG. 25 may be used as a circuit diagram of the LCD shown in FIG. 27.

As shown in FIGS. 25 and 27, a plurality of pixel electrodes 190a and 190b, and a plurality of contact assistants 81 and 82, are formed on the passivation layer 180.

A first pixel electrode 190a has a shape of a bent band following the shape of the pixel area, and it has a bent oblique line shaped first cutout 191a. A second pixel electrode 190b includes two separate parallelograms, and each parallelogram has an oblique line shaped second cutout 191b. The first pixel electrode 190a is disposed between the two parallelograms of the second pixel electrode 190b. The first pixel electrode 190a and the second pixel electrode 190b occupy substantially the same area. First and second cutouts 191a and 191b divide the first pixel electrode 190a and the second pixel electrode 190b, respectively. A direction control electrode 178 overlaps the first and second cutouts 191a and 191b.

The voltages of the first and second pixel electrodes 190a and 190b may be adjusted by changing their locations.

When a pixel area includes two sub-areas with somewhat different electric fields, lateral visibility is improved by the mutual compensation in the two sub-areas.

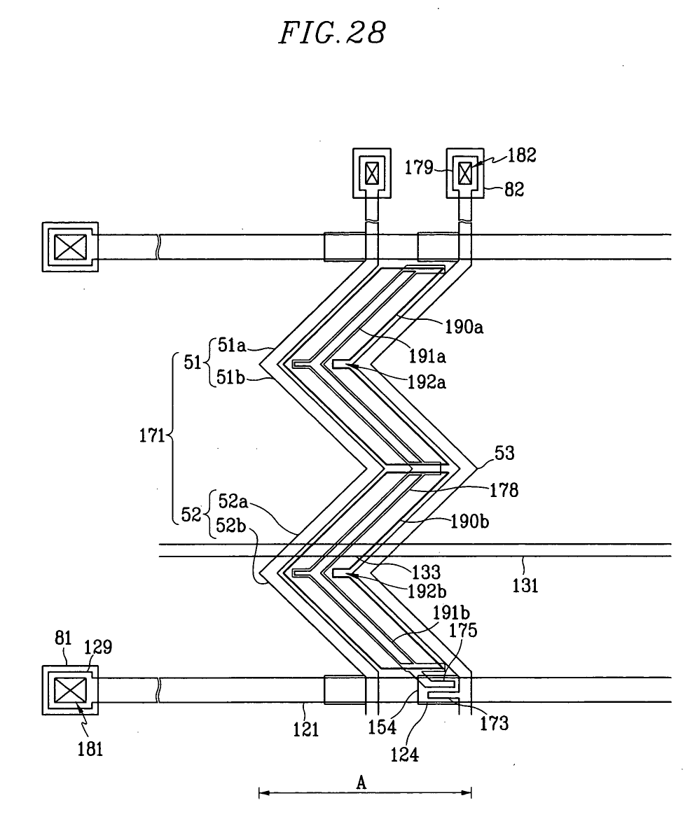

FIG. 28 is a plan view of an LCD according to a fourteenth exemplary embodiment of the present invention. FIG. 25 may be used as a circuit diagram of the LCD shown in FIG. 28.

As shown in FIG. 28, each data line 171 is bent repeatedly and includes a plurality of pairs of oblique portions 51a, 51b, 52a, and 52b, and a plurality of longitudinal portions.

Two pairs of oblique portions 51a and 51b, 52a and 52b connect to form a double chevron 51 and 52.

The first oblique portions 51a and 52a make an angle of about 30 to 60 degrees (preferably 45 degrees) with the gate lines, and the second oblique portions 51b and 52b make an angle of about 120 to 150 degrees (preferably 135 degrees).

The double chevron 51 and 52 includes a first chevron 51 and a second chevron 52 that are connected to each other and have substantially the same shape.

A plurality of branches of each data line 171, which project toward drain electrodes 175, form a plurality of source electrodes 173. The longitudinal portion of the data line 171 crosses a gate line 121.

Therefore, the gate lines 121 and the data lines 171 define a pixel area having a triple vent band shape.

Chevron-shaped first pixel electrodes 190a and second pixel electrodes 190b are formed in each pixel area. The first pixel electrode 190a corresponds to the first chevron 51, and it has a first chevron cutout 191a dividing it into right and left portions. The second pixel electrode 190b corresponds to the second chevron 52, and it has a second chevron cutout 191b dividing it into right and left portions. The first pixel electrode 190a and the second pixel electrode 190b have horizontal cutouts 192a and 192b, respectively, which divide their right portions into lower right portions and upper right portions. The first and second chevron cutouts 191a and 191b include horizontal branches that divide the left portions of the first and second pixel electrodes 190a and 190b, respectively, into lower left portions and upper left portions.

A direction control electrode 178 overlaps the first and second chevron cutouts 191a and 191b.

The voltage Vpa, of the first pixel electrode 190a, and the voltage Vpb, of the second pixel electrode 190b, may differ by adjusting an overlapping area or a distance between the direction control electrode 178 and the first and the second pixel electrodes 190a and 190b, or by adjusting occupying areas of the first and second pixel electrode 190a and 190b in a pixel area.

When a pixel area includes two sub-areas with somewhat different electric fields, lateral visibility is improved by the mutual compensation in the two sub-areas.

If a pixel area includes three or more pixel electrodes, a pixel area may include three or more sub-areas with somewhat different electric fields to improve lateral visibility.

The fourteenth exemplary embodiment of FIG. 28 shows a pixel shape of a triple vent band, which helps reduce the pixel area's width. A reduction of the horizontal width of the pixel area is helpful to prevent a character from being seen as broken.

The ninth through fourteenth exemplary embodiments of FIGS. 19 to 28 show LCDs without domain control members formed in the common electrode. Therefore, exact alignment between the TFT panel and the common electrode panel is not critical for domain division, which permits widening of the LCD.

In the above described exemplary embodiments, the color filters are formed on the common electrode panel. However, the color filters may alternatively be formed between the passivation layer and the pixel electrodes on the TFT array panel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A thin film transistor array panel for an LCD, comprising:
a first signal line formed on a substrate;
a second signal line, having at least a bent portion, formed on the substrate;
a pixel area defined by the first signal line and the second signal line; and
a first pixel electrode and a second pixel electrode disposed in the pixel area;
wherein the pixel area has a bent shape;
wherein the first pixel electrode is coupled to a thin film transistor and the second pixel electrode is coupled to the first pixel electrode.

2. The thin film transistor array panel of claim 1, further comprising a coupling electrode extending from a drain electrode of a thin film transistor and overlapping the second pixel electrode.

3. The thin film transistor array panel of claim 1, wherein the second signal line has a longitudinal portion that intersects the first signal line and an oblique portion forming a chevron shaped portion.

4. The thin film transistor array panel of claim 3, wherein the oblique portions forming the chevron shaped portion is about one to nine times longer than the longitudinal portion that intersects the first signal line.

5. The thin film transistor array panel of claim 2, wherein the first pixel electrode is coupled to the drain electrode of the thin film transistor through a via hole.

6. The thin film transistor array panel of claim 5, wherein the first pixel electrode is coupled to the drain electrode of the thin film transistor through a via hole exposing the coupling electrode extending from the drain electrode of the thin film transistor.

7. The thin film transistor array panel of claim 6, wherein the second pixel electrode consists of two separate parallelograms.

8. The thin film transistor array panel of claim 6, wherein the first pixel electrode consists of two separate parallelograms and each separate parallelogram is coupled to the drain electrode of the thin film transistor through a via hole exposing the coupling electrode extending from the drain electrode of the thin film transistor.

9. The thin film transistor array panel of claim 1, wherein a voltage of the second pixel electrode with respect to a common voltage is less than the voltage of the first pixel electrode.

10. The thin film transistor array panel of claim 2, wherein the second signal line, the drain electrode, and the coupling electrode are formed directly on an ohmic contact layer.

11. The thin film transistor array panel of claim 2, wherein the second signal line is formed on an ohmic contact layer and a portion of a gate insulating layer, the drain electrode has a portion formed directly on the gate insulating layer, and the coupling electrode is formed directly on the gate insulating layer.

12. A thin film transistor array panel for an LCD, comprising:
a first signal line formed on a substrate;
a second signal line, having at least a bent portion, formed on the substrate;
a pixel area defined by the first signal line and the second signal line; and
a first pixel electrode and a second pixel electrode, both disposed in the pixel area and electrically floated from a thin film transistor;
a direction control electrode, disposed in the pixel area, and coupled to the thin film transistor;
wherein the pixel area has a bent shape;
wherein a portion of at least one of the first pixel electrode or the second pixel electrode overlaps the direction control electrode.

13. The thin film transistor array panel of claim 12, wherein the first pixel electrode and the second pixel electrode are physically connected to each other at their ends and the direction control electrode overlaps with a portion of the first pixel electrode and the second pixel electrode.

14. The thin film transistor array panel of claim 12, wherein the first pixel electrode and the second pixel electrode are separated by a predetermined distance and the direction control electrode overlaps a portion of the first pixel electrode and the second pixel electrode.

15. The thin film transistor array panel of claim 12, further comprising a second direction control electrode, wherein the second direction control electrode overlaps a portion of the second pixel electrode and the first direction control electrode overlaps a portion of the first pixel electrode.

16. The thin film transistor array panel of claim 15, wherein a voltage of the second direction control electrode is greater than a voltage of the second pixel electrode and a voltage of the first direction control electrode is greater than a voltage of the first pixel electrode.

17. The thin film transistor array panel of claim 16, wherein the voltage of the second pixel electrode is different from the voltage of the first pixel electrode by a predetermined value.

18. The thin film transistor array panel of claim 12, wherein a voltage of the direction control electrode is greater than a voltage of the second pixel electrode and a voltage of the first pixel electrode.

19. The thin film transistor array panel of claim 15, further comprising an electrode, formed between the second pixel electrode and the first pixel electrode, that overlaps with portions of the first pixel electrode and the second pixel electrode.

20. The thin film transistor array panel of claim 12, wherein the first pixel electrode is formed in a chevron shape and the second pixel electrode consists of two separate parallelograms.

21. The thin film transistor array panel of claim 12, wherein the pixel area has a first chevron shaped portion and a second chevron shaped portion and the first pixel electrode is disposed in the first chevron shaped portion and the second pixel electrode is disposed in the second chevron shaped portion.

22. A liquid crystal display (LCD), comprising:
an upper substrate;
a lower substrate; and
a liquid crystal layer interposed therebetween;
wherein the lower substrate further comprises:
a first signal line formed on the lower substrate;
a second signal line, having at least a bent portion, formed on the lower substrate;
a pixel area defined by the first signal line and the second signal line; and
a first pixel electrode and a second pixel electrode disposed in the pixel area;
wherein at least a portion of the pixel area has a bent shape;
wherein the first pixel electrode is coupled to a thin film transistor and the second pixel electrode is coupled to the first pixel electrode.

23. The LCD of claim 22, wherein the upper substrate has a common electrode with a domain control means.

24. The LCD of claim 23, wherein the domain control means is a cutout that is about 9 μm to about 12 μm wide.

25. The LCD of claim 23, wherein the domain control means is organic protrusions having a width in the range of 5 μm to 10 μm.

26. The LCD of claim 23, wherein edges of the first pixel electrode, edges of the second pixel electrode, and edges of the cutout form a domain of liquid crystals in the pixel area, and the domain is about 10 μm to about 30 μm wide.

27. A liquid crystal display, comprising:
an upper substrate;
a lower substrate; and
a liquid crystal layer interposed therebetween;
wherein the lower substrate further comprises:
a first signal line formed on the lower substrate;
a second signal line, having at least a bent portion, formed on the lower substrate;
a pixel area defined by the first signal line and the second signal line; and
a first pixel electrode and a second pixel electrode, both disposed in the pixel area and electrically floated from a thin film transistor;
a direction control electrode, disposed in the pixel area, and coupled to the thin film transistor;
wherein the pixel area has a bent shape;
wherein a portion of at least one of the first pixel electrode or the second pixel electrode overlaps the direction control electrode.

28. The LCD of claim 27, wherein at least one of the first pixel electrode or the second pixel electrode has a cutout.

29. The LCD of claim 28, wherein edges of the first pixel electrode, edges of the second pixel electrode, and edges of the cutout form a domain of liquid crystals in the pixel area, and the domain is about 10 μm to about 30 μm wide.
